(19) United States
(12) Patent Application Publication
(10) Pub. No.: US 2026/0149964 A1
(43) Pub. Date: May 28, 2026

(54) Method and Apparatus for User Plane Security of Virtual Network Group

(71) Applicant: Telefonaktiebolaget LM Ericsson (publ), Stockholm (SE)

(72) Inventor: Hongxia Long, Shanghai (CN)

(21) Appl. No.: 19/121,839

(22) PCT Filed: Oct. 17, 2023
(86) PCT No.: PCT/CN2023/124896

§ 371 Date: Apr. 17, 2025

(30) Foreign Application Priority Data
Oct. 21, 2022 (WO) PCT/CN2022/126721

(51) Int. Cl. H04W 12/033; H04W 8/18; H04W 12/106

(52) U.S. Cl. CPC H04W 12/033; H04W 8/186; H04W 12/106

(57) ABSTRACT

Embodiments of the present disclosure provide method and apparatus for user plane security of VN group. A method performed by an exposure function comprises receiving a first message comprising at least one parameter to be created or updated from an application node. The at least one parameter to be created or updated comprises user plane (UP) security information for a virtual network (VN) group. The method may further comprise sending a second message comprising the at least one parameter to be created or updated to a data management node or a data repository node.

### TECHNICAL FIELD

The non-limiting and exemplary embodiments of the present disclosure generally relate to the technical field of communications, and specifically to methods and apparatuses for user plane security of virtual network (VN) group.

### BACKGROUND

This section introduces aspects that may facilitate a better understanding of the disclosure. Accordingly, the statements of this section are to be read in this light and are not to be understood as admissions about what is in the prior art or what is not in the prior art.

The VN group may be supported in various networks. For example, in communication networks for example new radio (NR) as defined by 3rd Generation Partnership Project (3GPP), it supports fifth generation (5G) VN group communication.

As described in clause 4.15.6.2 of 3GPP TS 23.502 V17.5.0, the disclosure of which is incorporated by reference herein in its entirety, the information of 5G VN group may be provided by an application function (AF) to an network exposure function (NEF) and is stored in a unified data repository (UDR), by using the NEF service operations information flow procedure.

Clause 4.4.15 of 3GPP TS 29.522 V17.7.0, the disclosure of which is incorporated by reference herein in its entirety, described NEF 5G Local Area Network (LAN) Parameter Provisioning as following.

### 4.4.15.1 General

The procedures are used by the AF to provision 5G LAN type service related parameters to the NEF. The following procedures support:
Management of 5G Virtual Network group membership; and/or
Management of 5G Virtual Network group data

### 4.4.15.2 Creation of a New Subscription for 5G LAN Parameter Provisioning

In order to create a new subscription to provision 5G LAN related parameters, the AF shall initiate an HTTP POST request to the NEF for the “5GLAN Parameters Provision Subscriptions” resource. The body of the HTTP POST message shall include the 5G LAN service related parameters within the “5gLanParams” attribute.

Upon receipt of the corresponding HTTP POST message, if the AF is authorized by the NEF to provision the parameters, the NEF shall interact with the UDM to create a subscription at the UDM by using Nudm_ParameterProvision service as defined in 3GPP TS 29.503 [17]. If the request is accepted by the UDM and the UDM informs the NEF with a successful response, the NEF shall create a new subscription and assign a subscription identifier for the “Individual 5GLAN Parameters Provision Subscription” resource. Then the NEF shall send a HTTP “201 Created” response with 5GLanParametersProvision data structure as response body and a Location header field containing the URI of the created individual subscription resource.

### 4.4.15.3 Modification of an Existing Subscription for 5G LAN Parameter Provisioning

To modify an existing subscription to provision 5G LAN parameters, the AF shall initiate an HTTP PUT/PATCH request to the NEF for the “Individual 5GLAN Parameters Provision Subscription” resource. The body of the HTTP PUT message shall include the 5GLanParametersProvision data type as defined in clause 5.7.2.3.2. The External Group Identifier, DNN, S-NSSAI and PDU session type(s) shall remain unchanged from previous values. The body of the HTTP PATCH message shall include the 5GLanParametersProvisionPatch data as defined in clause 5.7.2.3.5.

Upon receipt of the corresponding HTTP PUT/PATCH message, if the AF is authorized by the NEF to provision the parameters, the NEF shall interact with the UDM to modify an existing subscription at the UDM by using Nudm_ParameterProvision service as defined in 3GPP TS 29.503 [17]. If the modification request is accepted by the UDM and the UDM informs the NEF with a successful response, the NEF shall update the existing subscription for the “Individual 5GLAN Parameters Provision Subscription” resource. Then the NEF shall send a HTTP response including “200 OK” status code with 5GLanParametersProvision data structure or “204 No Content” status code.

### 4.4.15.4 Deletion of an Existing Subscription for 5G LAN Parameter Provisioning

To delete an existing subscription to 5GLAN provision parameters, the AF shall initiate an HTTP DELETE request to the NEF for the “Individual 5GLAN Parameters Provision Subscription” resource.

Upon receipt of the corresponding HTTP DELETE message, if the AF is authorized. the NEF shall interact with the UDM to delete an existing parameters provision subscription at the UDM by using Nudm_ParameterProvision service as defined in 3GPP TS 29.503 [17]. If the request is accepted by the UDM and informs the NEF with a successful response, the NEF shall delete the existing subscription for the “Individual 5GLAN Parameters Provision Subscription” resource. Then the NEF shall send a HTTP “204 No Content” response.

Clause 5.7.2.3.3 of 3GPP TS 29.522 V17.7.0 described Type: 5GLanParameters as following.

### 5.7.2.3.3 Type: 5GLanParameters

This type represents the 5G LAN service related parameters need to be provisioned.

TABLE 5.7.2.3.3-1
Definition of type 5GLanParameters

| Attribute name | Data type | P | Cardinality | Description | Applicability |
|---|---|---|---|---|---|
| exterGroupId | ExternalGroupId | M | 1 | Identifies an 5G Virtual Network | |
| | | | | Group. | |
| gpsis | map(Gpsi) | M | 1 . . . N | Represents the list of 5G VN | |
| | | | | Group members, each member is | |
| | | | | identified by GPSI. | |
| | | | | Any string value can be used as a | |
| | | | | key of the map. | |
| dnn | Dnn | M | 1 | DNN for the 5G VN group, a full | |
| | | | | DNN with both the Network | |
| | | | | Identifier and Operator Identifier, | |
| | | | | or a DNN with the Network | |
| | | | | Identifier only. | |
| aaaIpv4Addr | Ipv4Addr | O | 1 | Identifies the DN-AAA server IPv4 | |
| | | | | address provided by AF, for the | |
| | | | | secondary | |
| | | | | authentication/authorization | |
| | | | | and/or UE IP address allocation | |
| | | | | by DN-AAA server. | |
| aaaIpv6Addr | Ipv6Addr | O | 1 | Identifies the DN-AAA server IPv6 | |
| | | | | address provided by AF, for the | |
| | | | | secondary | |
| | | | | authentication/authorization | |
| | | | | and/or UE IP address allocation | |
| | | | | by DN-AAA server. | |
| aaaUsgs | array(AaaUsage) | O | 1 . . . 2 | Identifies the usage needs for | |
| | | | | secondary | |
| | | | | authentication/authorization | |
| | | | | and/or UE IP address allocation | |
| | | | | from the DN-AAA server. | |
| mtcProviderId | MtcProviderInformation | O | 0 . . . 1 | Indicates MTC provider | |
| | | | | information for 5G VN Group | |
| | | | | Configuration authorization. | |
| | | | | (NOTE 1) | |
| snssai | Snssai | M | 1 | S-NSSAI for the 5G VN group. | |
| sessionType | PduSessionType | M | 1 | PDU Session Type allowed for 5G | |
| | | | | VN group. | |
| sessionTypes | array(PduSessionType) | O | 1 . . . N | If further PDU Session Types (in | multipleSessionTypes |
| | | | | addition to the PDU Session Type | |
| | | | | indicated in the “sessionType” | |
| | | | | attribute) are allowed for the 5G | |
| | | | | VN group, they are provided in | |
| | | | | this attribute. (NOTE 2) | |
| appDesps | map(AppDescriptor) | M | 1 . . . N | Describes the operation systems | |
| | | | | and the corresponding | |
| | | | | applications for each operation | |
| | | | | systems. The key of map is osId. | |

(NOTE 1):
The NEF should check received MTC Provider information and then the NEF may:
override it with local configured value and send it to UDM;
send it directly to the UDM; or
reject the 5G VN Group Configuration request.
(NOTE 2):
Only one PDU Session type is applied for a PDU Session of a VN group at a time.

Clause 5.6.2.1 of 3GPP TS 29.503 V17.8.0, the disclosure of which is incorporated by reference herein in its entirety, described NEF 5G LAN Parameter Provisioning as following.

### 5.6.2.1 Introduction

For the Nudm_ParameterProvision service the following service operations are defined:
Update
Create
Delete
Get

The Nudm_ParameterProvision service is used by consumer NFs (e.g. NEF) to update a UE's or a group of UEs' subscription data by means of the Update service operation.

For details see 3GPP TS 23.502 [3] clause 4.15.6.2.

The Nudm_ParameterProvision service can also be used by a NF Service Consumer (e.g. SOR-AF) to send updated Steering of Roaming Information for a UE to the UDM at any time, as specified in Annex C.3 of 3GPP [symbol] [symbol] .

### 5G-VN-Group Creation

FIG. 1a shows a scenario where the NF service consumer sends a request to the UDM to create a 5G VN Group, which is same as FIG. 5.6.2.3.2-1 of 3GPP TS 29.503 V17.8.0.

The request contains the group's external identifier and the group configuration.

Clause 5.6.2.3.2 of 3GPP TS 29.503 V17.8.0 described the steps as following.
1. The NF service sends consumer a PUT request to the resource . . . /5g-vn-groups/{extGroupId}, to create a 5G VN Group as present in the message body.

If MTC Provider information and/or AF ID are received in the request, the UDM shall check whether the MTC Provider and/or the AF is allowed to perform this operation for the UE; otherwise, the UDM shall skip the MTC provider and/or AF authorization check.
2a. On success the UDM responds with “201 Created”.
2b. If the creation can't be accepted (e.g. MTC Provider or AF are not allowed to perform this operation for the UE), HTTP status code “403 Forbidden” should be returned including additional error information in the response body (in the “ProblemDetails” element).

On failure, the appropriate HTTP status code indicating the error shall be returned and appropriate additional error information should be returned in the PUT response body.

FIG. 1b shows a scenario where the NF service consumer sends a request to the UDM to modify an external group id's group data, which is same as FIG. 5.6.2.2.3-1 of 3GPP TS 29.503 V17.8.0.

The request contains the external group identifier of the group and the modification instructions.

Clause 5.6.2.2.3 of 3GPP TS 29.503 V17.8.0 described the steps as following.
1. The NF service consumer sends a PATCH request to the resource that represents a 5G VN Group.

If MTC Provider information and/or AF ID are received in the request, the UDM shall check whether the MTC Provider and/or the AF is allowed to perform this operation for the UE; otherwise, the UDM shall skip the MTC provider and/or AF authorization check.

2a. On success, the UDM responds with “204 No Content”.
2b. If the external group id does not exist in the UDM, HTTP status code “404 Not Found” shall be returned including additional error information in the response body (in the “ProblemDetails” element).
2c. If MTC Provider or AF are not allowed to perform this operation for the UE, HTTP status code “403 Forbidden” shall be returned including additional error information in the response body (in the “ProblemDetails” element).

On failure, the appropriate HTTP status code indicating the error shall be returned and appropriate additional error information should be returned in the PATCH response body.

FIG. 1c shows a scenario where the NF service consumer sends a request to the UDM to delete a 5G VN Group, which is same as FIG. 5.6.2.4.2-1 of 3GPP TS 29.503 V17.8.0.

The request contains the group's external identifier.

Clause 5.6.2.4.2 of 3GPP TS 29.503 V17.8.0 described the steps as following.
1. The NF service consumer sends a DELETE request to the resource . . . /5g-vn-groups/{extGroupId}, to delete the 5G VN Group identified by the external group id.

If MTC Provider information and/or AF ID are received in the request, the UDM shall check whether the MTC Provider and/or the AF is allowed to perform this operation for the UE; otherwise, the UDM shall skip the MTC provider and/or AF authorization check.
2a. On success, the UDM responds with “204 No Content”.
2b. If the external group id does not exist in the UDM, HTTP status code “404 Not Found” shall be returned including additional error information in the response body (in the “ProblemDetails” element).
2c. If MTC Provider or AF are not allowed to perform this operation for the UE. HTTP status code “403 Forbidden” shall be returned including additional error information in the response body (in the “ProblemDetails” element).

On failure, the appropriate HTTP status code indicating the error shall be returned and appropriate additional error information should be returned in the DELETE response body.

FIG. 1d shows a scenario where the NF service consumer sends a request to the UDM to get 5G VN Group, which is same as FIG. 5.6.2.5.2-1 of 3GPP TS 29.503 V17.8.0.

The request contains the group's external identifier.

Clause 5.6.2.5.2 of 3GPP TS 29.503 V17.8.0 described the steps as following.
1. The NF service consumer sends a GET request to the resource . . . /5g-vn-groups/{extGroupId}, to get the 5G VN Group identified by the external group id.
2a. On success, the UDM responds with “200 Ok” with the VPN Group Information
2b. If the external group id does not exist in the UDM, HTTP status code “404 Not Found” shall be returned including additional error information in the response body (in the “ProblemDetails” element).
2c. If the original AF is not allowed to get this information, HTTP status code “403 Forbidden” shall be returned including additional error information in the response body (in the “ProblemDetails” element).

On failure, the appropriate HTTP status code indicating the error shall be returned and appropriate additional error information should be returned in the GET response body.

Clause 6.5.6.2.6 of 3GPP TS 29.503 V17.8.0 described the definition of type 5GVnGroupConfiguration as following.

TABLE 6.5.6.2.6-1
Definition of type 5GVnGroupConfiguration

| Attribute name | Data type | P | Cardinality | Description |
|---|---|---|---|---|
| 5gVnGroupData | 5GVnGroupData | C | 0 . . . 1 | Data of the 5G VN Group; may be absent in |
| | | | | modification requests; shall be present otherwise |
| members | array(Gpsi) | C | 1 . . . N | List of group members; may be absent in |
| | | | | modification requests; shall be present in creation |
| | | | | requests |
| referenceId | ReferenceId | C | 1 | Transaction Reference ID; shall be absent in |
| | | | | modification requests; shall be present otherwise. |
| afInstanceId | string | C | 1 | The string identifying the originating AF (NOTE) |
| internalGroupIdentifier | GroupId | C | 0 . . . 1 | Allocated by the UDR; shall be present in successful |
| | | | | PUT and GET responses on Nudr; otherwise shall |
| | | | | be absent. |
| mtcProviderInformation | MtcProviderInformation | O | 0 . . . 1 | Indicates MTC provider information for 5G VN |
| | | | | Group Configuration authorization. |

(NOTE):
When the service operation is originated by external AF via T8/N33 interface, information carried in {scsAsId} URI variable in resource URIs on T8/N33 interface (see clause 5 of 3GPP TS 29.122 [45]) or in {afId} URI variable in resource URIs on N33 interface (see clause 5 of 3GPP TS 29.522 [54]) can be used as the value for this IE.

Clause 6.5.6.2.7 of 3GPP TS 29.503 V17.8.0 described the definition of type 5GVnGroupData as following.

TABLE 6.5.6.2.7-1
Definition of type 5GVnGroupData

| Attribute name | Data type | P | Cardinality | Description |
|---|---|---|---|---|
| dnn | Dnn | M | 1 | DNN of the 5G VN group, shall contain the Network |
| | | | | Identifier only. |
| sNssai | Snssai | M | 1 | S-NSSAI of the 5G VN group's communication |
| | | | | session |
| pduSessionTypes | array(PduSessionType) | O | 1 . . . N | List of PDU Session Types allowed for 5G VN |
| | | | | group's communication session |
| appDescriptors | array(AppDescriptor) | O | 1 . . . N | List of Application Descriptors allowed for 5G VN |
| | | | | group's communication session |
| secondaryAuth | boolean | O | 0 . . . 1 | Indicates whether secondary authentication and |
| | | | | authorization is needed. |
| | | | | true: secondary authentication and authorization is |
| | | | | needed. |
| | | | | false: secondary authentication and authorization is |
| | | | | not needed. |
| | | | | If absent, it indicates that secondary authentication |
| | | | | is not required by the NEF, but it still may be |
| | | | | required by local policies at the SMF. |
| dnAaaIpAddressAllocation | boolean | O | 0 . . . 1 | Indicates whether the SMF is required to request the |
| | | | | UE IP address from the DN-AAA server for PDU |
| | | | | Session Establishment. |
| | | | | true: required |
| | | | | false: not required |
| | | | | If absent, it indicates that the request by SMF of the |
| | | | | UE IP address from the DN-AAA server is not |
| | | | | required, but it still may be required by local |
| | | | | policies at the SMF. |
| dnAaaAddress | IpAddress | O | 0 . . . 1 | The IP address of the DN-AAA server, used for |
| | | | | secondary authentication and authorization. |
| additionalDnAaaAddresses | array(IpAddress) | O | 1 . . . N | Additional IP addresses of the DN-AAA server used |
| | | | | for secondary authentication and authorization. |
| dnAaaFqdn | Fqdn | O | 0 . . . 1 | The FQDN of the DN-AAA server used for |
| | | | | secondary authentication and authorization. |

Clause 6.1.6.2.39 of 3GPP TS 29.503 V17.8.0 described the definition of type VnGroupData as following.

TABLE 6.1.6.2.39-1
Definition of type VnGroupData

| Attribute name | Data type | P | Cardinality | Description |
|---|---|---|---|---|
| pduSessionTypes | PduSessionTypes | O | 0 . . . 1 | Allowed session types |
| dnn | Dnn | O | 0 . . . 1 | Data Network Name with Network Identifier only. |
| | | | | (NOTE) |
| singleNssai | Snssai | O | 0 . . . 1 | Single Nssai |
| appDescriptors | array(AppDescriptor) | O | 1 . . . N | List of Application Descriptors |

(NOTE):
Only a 1:1 mapping between DNN and 5G VN group is supported in this release

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

For example, to reduce incremental complexity added by security, all PDU sessions associated with a specific VN (such as 5G LAN) group should have the same user plane security policy. But there is lack of functionality on the existing parameter provisioning interface to configure the same user plane security for a VN Group. In addition, in the shared VN group data, user plane security is not available in the existing data model. There are some problems of the existing solutions for user plane security of VN group as following.
Problem 1: It is not possible for an external application function or external enterprise application or external vertical application in an untrusted environment to configure the same user plane security for a VN group as there is no service based interface exposed by exposure function such as NEF for such purpose.
Problem 2: It is only possible to configure the user plane security at individual level in a trusted environment. It means when comes to a VN group with a large group size, it must be configured one member by one member of such group, which is error prone and time consuming especially when the size of the group is not small, for example, hundreds or thousands of group members.
Problem 3: There is no way for conflicting resolving if user plane security is configured inconsistently. For example member A is configured with user plane security profile 1 and member B is configured with user plane security profile 2 at individual level which is not equal to user plane security profile 1, how to enforce the same user plane security for the VN group is uncertain and user plane security consistency for the whole VN group maybe breached.

To overcome or mitigate at least one of above mentioned problems or other problems, the embodiments of the present disclosure propose an improved solution for user plane security of VN group.

In an embodiment, it is proposed to enhanace the parameter provisioning interface for provisioning the same user plane security for a VN (such as 5G LAN) group.

In an embodiment, it is proposed to enhance the shared VN group data to have the same user plane security for the VN group.

In a first aspect of the disclosure, there is provided a method performed by an exposure function. The method may comprise receiving a first message comprising at least one parameter to be created or updated from an application node. The at least one parameter to be created or updated may comprise user plane (UP) security information for a virtual network (VN) group. The method may further comprise sending a second message comprising the at least one parameter to be created or updated to a data management node or a data repository node.

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the first message may comprise at least one of a parameter provision create request, or a parameter provision update request.

In an embodiment, the second message may comprise at least one of a parameter provision create request, or a parameter provision update request.

In an embodiment, the application node may comprise at least one of an application function (AF), a services capability server (SCS), or an application server (AS).

In an embodiment, the data management node may comprise a unified data management (UDM) and/or the data repository node may comprise a home subscriber server (HSS) or a home location register (HLR).

In an embodiment, the exposure function may comprise at least one of a service capability exposure function (SCEF), a network exposure function (NEF), or a SCEF combined with NEF.

In a second aspect of the disclosure, there is provided a method performed by a data management node. The method may comprise receiving a second message comprising at least one parameter to be created or updated from an exposure function or an application function (AF). The at least one parameter to be created or updated may comprise user plane (UP) security information for a virtual network (VN) group. The method may further comprise sending a third message comprising the at least one parameter to be created or updated to a data repository node.

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the second message may comprise at least one of a parameter provision create request, or a parameter provision update request.

In an embodiment, the third message may comprise at least one of a data management create request, or a data management update request.

In an embodiment, the data repository node may comprise a unified data repository (UDR).

In an embodiment, the data management node may comprise a unified data management (UDM).

In an embodiment, the exposure function may comprise a network exposure function (NEF).

In an embodiment, the method may further comprise receiving a first request for retrieving shared data for the VN group from a session management function. The method may further comprise sending a second request for retrieving shared data for the VN group to the data repository node. The method may further comprise receiving a second response comprising shared data for the VN group from the data repository node. The method may further comprise sending a first response comprising shared data for the VN group to the session management function. The shared data for the VN group may comprise the UP security information for the VN group.

In an embodiment, the method may further comprise receiving a third request for subscribing data change notification for the VN group from a session management function. The method may further comprise sending a fourth request for subscribing data change notification for the VN group to the data repository node. The method may further comprise receiving a first data change notification message comprising the UP security information for the VN group from the data repository node. The method may further comprise sending a second data change notification message comprising the UP security information for the VN group to the session management function.

In a third aspect of the disclosure, there is provided a method performed by an application node. The method may comprise sending a first message comprising at least one parameter to be created or updated to an exposure function or a data management node or a data repository node. The at least one parameter to be created or updated may comprise user plane (UP) security information for a virtual network (VN) group.

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the first message may comprise at least one of a parameter provision create request, or a parameter provision update request.

In an embodiment, the application node may comprise at least one of an application function (AF), a services capability server (SCS), or an application server (AS).

In an embodiment, the exposure function may comprise at least one of a service capability exposure function (SCEF), a network exposure function (NEF), or a SCEF combined with NEF.

In an embodiment, the data repository node may comprise at least one of a home subscriber server (HSS), or a home location register (HLR).

In an embodiment, the data management node may comprise a unified data management (UDM).

In a fourth aspect of the disclosure, there is provided a method performed by a network management node. The method may comprise sending a fourth message comprising at least one parameter to be created or updated to a data repository node. The at least one parameter to be created or updated may comprise user plane (UP) security information for a virtual network (VN) group.

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the fourth message may comprise at least one of a parameter provision create request, or a parameter provision update request.

In an embodiment, the network management node may comprise a Communications Service Provider (CSP) provisioning system.

In an embodiment, the data repository node may comprise a unified data repository (UDR) or a home subscriber server (HSS) or a home location register (HLR).

In a fifth aspect of the disclosure, there is provided a method performed by a data repository node. The method comprising receiving a message comprising at least one parameter to be created or updated from a data management node or an exposure function or an application node or a network management node. The at least one parameter to be created or updated may comprise user plane (UP) security information for a virtual network (VN) group. The method may further comprise storing the at least one parameter to be created or updated.

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the message may comprise at least one of a data management create request, or a data management update request.

In an embodiment, the data repository node may comprise at least one of a home subscriber server (HSS), a home location register (HLR), or a unified data repository (UDR).

In an embodiment, the data management node may comprise a unified data management (UDM).

In an embodiment, the exposure function may comprise at least one of a service capability exposure function (SCEF), a network exposure function (NEF), or a SCEF combined with NEF.

In an embodiment, the application node may comprise at least one of an application function (AF), a services capability server (SCS), or an application server (AS).

In an embodiment, the network management node may comprise a CSP provisioning system.

In an embodiment, the method may further comprise allocating an internal group identifier (ID) if the internal group identifier is not allocated for the VN group identified by an external group ID. The method may further comprise storing a mapping between the internal group ID and the external group ID. The method may further comprise allocating a shared data ID for VN group data. The method may further comprise, for each member of the VN group, associating session management data with the internal group ID and the shared data ID.

In an embodiment, the method may further comprise receiving a request for retrieving shared data for the VN group from a data management node or a session management function. The method may further comprise sending a response comprising shared data for the VN group to the data management node or a session management function. The shared data for the VN group may comprise the UP security information for the VN group.

In an embodiment, the method may further comprise receiving a request for subscribing data change notification for the VN group from a data management node or a session management function. The method may further comprise sending a data change notification message to the data management node or a session management function. The data change notification message may comprise the UP security information for the VN group.

In a sixth aspect of the disclosure, there is provided a method performed by a session management function. The method may comprise sending a request for retrieving shared data for a VN group to a data management node or a data repository node. The method may further comprise receiving a response comprising shared data for the VN group from the data management node or the data repository node. The shared data for the VN group may comprise UP security information for the VN group.

In an embodiment, the method may further comprise sending a request for subscribing data change notification for the VN group to the data management node or a data repository node. The method may further comprise receiving a data change notification message from the data management node or a data repository node. The data change notification message may comprise the UP security information for the VN group.

In an embodiment, the method may further comprise determining whether a protocol data unit (PDU) session establishment is for an individual or group level communication. The method may further comprise, when the PDU session establishment is for the group level communication, setting same user plane security data from the UP security information for the VN group into a PDU session request to a radio access network through an access and mobility function.

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the data repository node may comprise at least one of a home subscriber server (HSS), or a home location register (HLR).

In an embodiment, the data management node may comprise a unified data management (UDM).

In a seventh aspect of the disclosure, there is provided an exposure function. The exposure function may comprise a processor and a memory coupled to the processor. Said memory contains instructions executable by said processor. Said exposure function is operative to receive a first message comprising at least one parameter to be created or updated from an application node. The at least one parameter to be created or updated may comprise user plane (UP) security information for a virtual network (VN) group. Said exposure function is further operative to send a second message comprising the at least one parameter to be created or updated to a data management node or a data repository node.

In an eighth aspect of the disclosure, there is provided a data management node. The data management node may comprise a processor and a memory coupled to the processor. Said memory contains instructions executable by said processor. Said data management node is operative to receive a second message comprising at least one parameter to be created or updated from an exposure function or an application function (AF). The at least one parameter to be created or updated may comprise user plane (UP) security information for a virtual network (VN) group. Said data management node is further operative to send a third message comprising the at least one parameter to be created or updated to a data repository node.

In a ninth aspect of the disclosure, there is provided an application node. The application node may comprise a processor and a memory coupled to the processor. Said memory contains instructions executable by said processor. Said application node is operative to send a first message comprising at least one parameter to be created or updated to an exposure function or a data management node or a data repository node. The at least one parameter to be created or updated may comprise user plane (UP) security information for a virtual network (VN) group. In a tenth aspect of the disclosure, there is provided a network management node.

The network management node may comprise a processor and a memory coupled to the processor. Said memory contains instructions executable by said processor. Said network management node is operative to send a fourth message comprising at least one parameter to be created or updated to a data repository node. The at least one parameter to be created or updated may comprise user plane (UP) security information for a virtual network (VN) group.

In an eleventh aspect of the disclosure, there is provided a data repository node. The data repository node may comprise a processor and a memory coupled to the processor. Said memory contains instructions executable by said processor. Said data repository node is operative to receive a message comprising at least one parameter to be created or updated from a data management node or an exposure function or an application node or a network management node.

The at least one parameter to be created or updated may comprise user plane (UP) security information for a virtual network (VN) group. Said data repository node is further operative to store the at least one parameter to be created or updated.

In a twelfth aspect of the disclosure, there is provided a session management function. The session management function may comprise a processor and a memory coupled to the processor. Said memory contains instructions executable by said processor. Said session management function is operative to send a request for retrieving shared data for a VN group to a data management node or a data repository node. Said session management function is further operative to receive a response comprising shared data for the VN group from the data management node or the data repository node. The shared data for the VN group may comprise UP security information for the VN group.

In another aspect of the disclosure, there is provided an exposure function. The exposure function may comprise a receiving module configured to receive a first message comprising at least one parameter to be created or updated from an application node. The at least one parameter to be created or updated may comprise user plane (UP) security information for a virtual network (VN) group. The exposure function may further comprise a sending module configured to send a second message comprising the at least one parameter to be created or updated to a data management node or a data repository node.

In another aspect of the disclosure, there is provided a data management node. The data management node may comprise a first receiving module configured to receive a second message comprising at least one parameter to be created or updated from an exposure function or an application function (AF). The at least one parameter to be created or updated may comprise user plane (UP) security information for a virtual network (VN) group. The data management node may further comprise a first sending module configured to send a third message comprising the at least one parameter to be created or updated to a data repository node.

In an embodiment, the data management node may further comprise a second receiving module configured to receive a first request for retrieving shared data for the VN group from a session management function.

In an embodiment, the data management node may further comprise a second sending module configured to send a second request for retrieving shared data for the VN group to the data repository node.

In an embodiment, the data management node may further comprise a third receiving module configured to receive a second response comprising shared data for the VN group from the data repository node.

In an embodiment, the data management node may further comprise a third sending module configured to send a first response comprising shared data for the VN group to the session management function. The shared data for the VN group may comprise the UP security information for the VN group.

In an embodiment, the data management node may further comprise a fourth receiving module configured to receive a third request for subscribing data change notification for the VN group from a session management function.

In an embodiment, the data management node may further comprise a fourth sending module configured to send a fourth request for subscribing data change notification for the VN group to the data repository node.

In an embodiment, the data management node may further comprise a fifth receiving module configured to receive a first data change notification message comprising the UP security information for the VN group from the data repository node.

In an embodiment, the data management node may further comprise a fifth sending module configured to send a second data change notification message comprising the UP security information for the VN group to the session management function.

In another aspect of the disclosure, there is provided an application node. The application node may comprise a sending module configured to send a first message comprising at least one parameter to be created or updated to an exposure function or a data management node or a data repository node. The at least one parameter to be created or updated may comprise user plane (UP) security information for a virtual network (VN) group.

In another aspect of the disclosure, there is provided a network management node. The network management node may comprise an sending module configured to send a fourth message comprising at least one parameter to be created or updated to a data repository node. The at least one parameter to be created or updated may comprise user plane (UP) security information for a virtual network (VN) group.

In another aspect of the disclosure, there is provided a data repository node. The data repository node may comprise a first receiving module configured to receive a message comprising at least one parameter to be created or updated from a data management node or an exposure function or an application node or a network management node. The at least one parameter to be created or updated may comprise user plane (UP) security information for a virtual network (VN) group. The data repository node may further comprise a first storing module configured to store the at least one parameter to be created or updated.

In an embodiment, the data repository node may further comprise a first allocating module configured to allocate an internal group identifier (ID) if the internal group identifier is not allocated for the VN group identified by an external group ID.

In an embodiment, the data repository node may further comprise a second storing module configured to store a mapping between the internal group ID and the external group ID.

In an embodiment, the data repository node may further comprise a second allocating module configured to allocate a shared data ID for VN group data.

In an embodiment, the data repository node may further comprise an associating module configured to, for each member of the VN group, associate session management data with the internal group ID and the shared data ID.

In an embodiment, the data repository node may further comprise a second receiving module configured to receive a request for retrieving shared data for the VN group from a data management node or a session management function.

In an embodiment, the data repository node may further comprise a first sending module configured to send a response comprising shared data for the VN group to the data management node or a session management function. The shared data for the VN group may comprise the UP security information for the VN group.

In an embodiment, the data repository node may further comprise a third receiving module configured to receive a request for subscribing data change notification for the VN group from a data management node or a session management function.

In an embodiment, the data repository node may further comprise a second sending module configured to send a data change notification message to the data management node or a session management function. The data change notification message may comprise the UP security information for the VN group.

In another aspect of the disclosure, there is provided a session management function. The session management function may comprise a first sending module configured to send a request for retrieving shared data for a VN group to a data management node or a data repository node. The session management function may further comprise a first receiving module configured to receive a response comprising shared data for the VN group from the data management node or the data repository node. The shared data for the VN group may comprise UP security information for the VN group.

In an embodiment, the session management function may further comprise a second sending module configured to send a request for subscribing data change notification for the VN group to the data management node or a data repository node.

In an embodiment, the session management function may further comprise a second receiving module configured to receive a data change notification message from the data management node or a data repository node. The data change notification message may comprise the UP security information for the VN group.

In an embodiment, the session management function may further comprise a determining module configured to determine whether a protocol data unit (PDU) session establishment is for an individual or group level communication.

In an embodiment, the session management function may further comprise a second sending module configured to, when the PDU session establishment is for the group level communication, set same user plane security data from the UP security information for the VN group into a PDU session request to a radio access network through an access and mobility function.

In another aspect of the disclosure, there is provided a computer program product comprising instructions which when executed by at least one processor, cause the at least one processor to perform the method according to any one of the first, second, third, fourth, fifth or sixth aspects.

In another aspect of the disclosure, there is provided a computer-readable storage medium storing instructions which when executed by at least one processor, cause the at least one processor to perform the method according to any one of the first, second, third, fourth, fifth or sixth aspects.

Embodiments herein may provide many advantages, of which a non-exhaustive list of examples follows. In some embodiments herein, the proposed solution can enable the possibility for external application or external enterprise application or vertical applications to configure the same user plane security of a VN group, this enhances the openness of communication service provider to monetize the diversified traffic carried by the network and enable more use cases for the network especially for vertical industries with requirements on same user plane security. In some embodiments herein, the proposed solution can enhance the manageability for same user plane security of VN groups, with the supported new configuration operations for creation, updating and deletion of the same user plane security in a unified service-based interfaces for VN groups. The deficiency and OPEX (operational expenditure) of the VN group management on the same user plane security is reduced. In some embodiments herein, with the recommended user plane security conflicting resolution mechanism, the flexibility is achieved to configure simultaneously the user plane security at individual level and at group level, and user plane security may be set differently for PDU session established for group communication than the one established for individual communication. In some embodiments herein, to reduce incremental complexity added by security, all PDU sessions associated with a specific LAN group should have the same user plane security configuration. This can be easily ensured by the proposed new methods on the user plane security enhancement for VN groups otherwise it would be time-consuming and laborious to rely solely on manual work to ensure that all the PDU sessions associated with a specific VN (such as 5G LAN) group have the same user plane security configuration. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a shows a scenario where the NF service consumer sends a request to the UDM to create a 5G VN Group;

FIG. 1b shows a scenario where the NF service consumer sends a request to the UDM to modify an external group id's group data;

FIG. 1c shows a scenario where the NF service consumer sends a request to the UDM to delete a 5G VN Group;

FIG. 1d shows a scenario where the NF service consumer sends a request to the UDM to get 5G VN Group;

FIG. 2a schematically shows a high level architecture in the fifth generation network according to an embodiment of the present disclosure;

FIG. 2b schematically shows system architecture in a 4G network according to an embodiment of the present disclosure;

FIG. 2c shows non-roaming architecture for Network Exposure Function in reference point representation;

FIG. 2d shows non-roaming Service Exposure Architecture for EPC-5GC Interworking;

FIG. 3 shows a flowchart of a method according to an embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 5 shows a flowchart of a method according to another embodiment of the present disclosure;

FIG. 6a shows a flowchart of a method according to another embodiment of the present disclosure;

FIG. 6b shows a flowchart of a method according to another embodiment of the present disclosure;

FIG. 6c shows a flowchart of a method according to another embodiment of the present disclosure;

FIG. 6d shows a flowchart of a method according to another embodiment of the present disclosure;

FIG. 6e shows a flowchart of a method according to another embodiment of the present disclosure;

FIG. 6f shows a flowchart of a method according to another embodiment of the present disclosure;

FIG. 6g shows a flowchart of a method according to another embodiment of the present disclosure;

FIG. 6h shows a flowchart of a method according to another embodiment of the present disclosure;

FIG. 7a shows a flowchart of AF provision user plane configuration data for a VN Group according to an embodiment of the present disclosure;

FIG. 7b shows a flowchart of CSP provision user plane security data for a VN Group according to an embodiment of the present disclosure;

FIG. 7c shows a flowchart of PDU session establishment procedure according to an embodiment of the present disclosure;

FIG. 8a is a block diagram showing an apparatus suitable for practicing some embodiments of the disclosure;

FIG. 8b is a block diagram showing an exposure function according to an embodiment of the disclosure;

FIG. 8c is a block diagram showing a data management node according to an embodiment of the disclosure:

FIG. 8d is a block diagram showing an application node according to an embodiment of the disclosure;

FIG. 8e is a block diagram showing a network management node according to an embodiment of the disclosure;

FIG. 8f is a block diagram showing a data repository node according to an embodiment of the disclosure; and

FIG. 9 is a block diagram showing a session management function according to an embodiment of the disclosure.

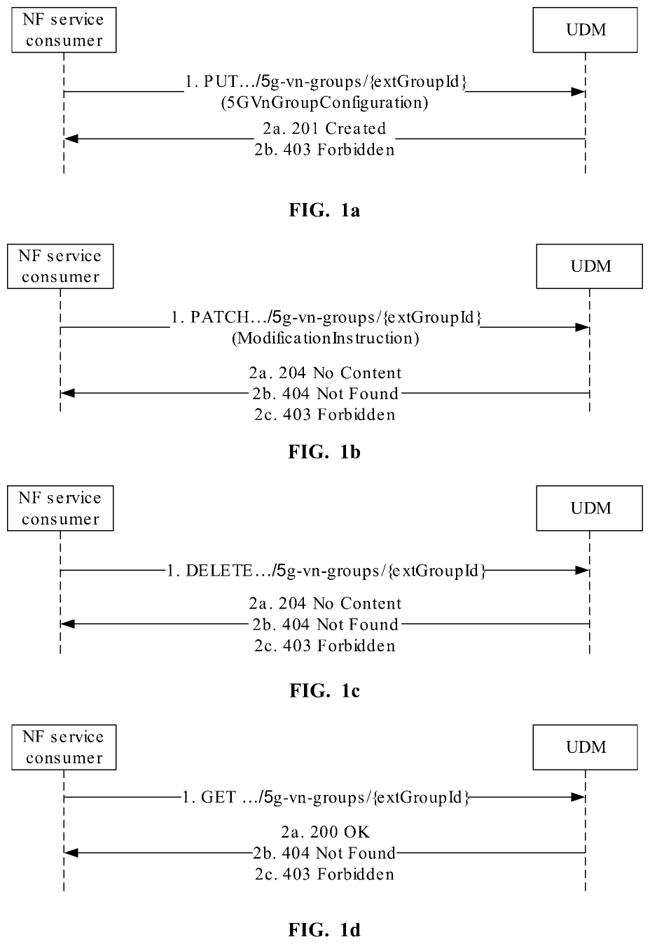

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HISS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for case of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

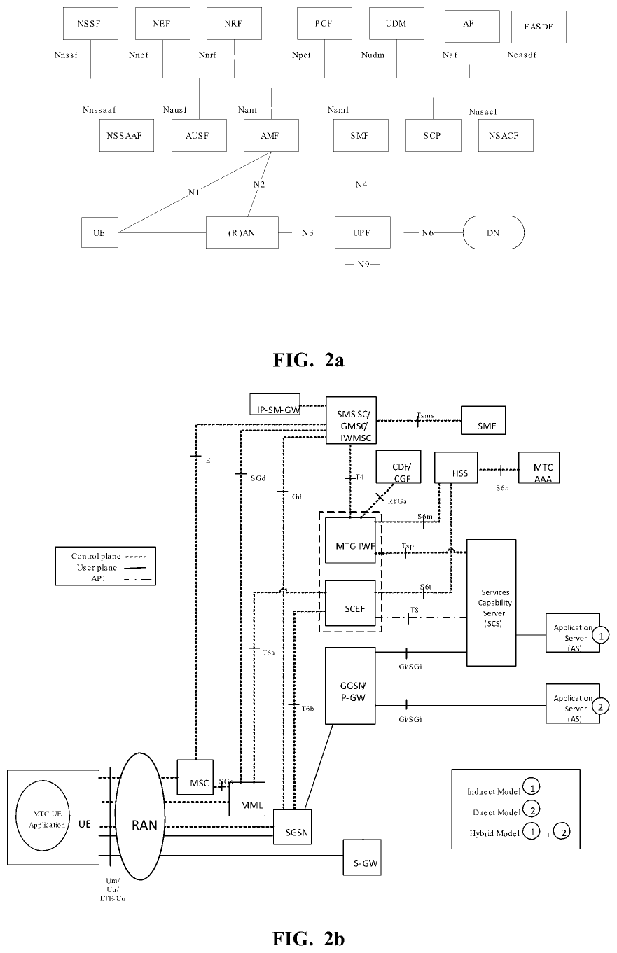

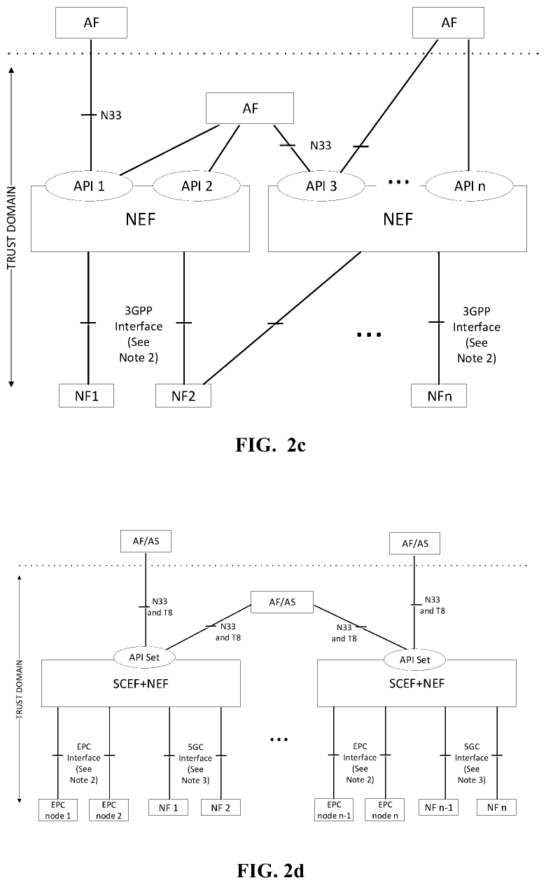

Although the subject matter described herein may be implemented in any appropriate type of system using any suitable components, the embodiments disclosed herein are described in relation to a communication system complied with the exemplary system architectures illustrated in FIGS. 2a-2d. For simplicity, the system architectures of FIGS. 2a-2d only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

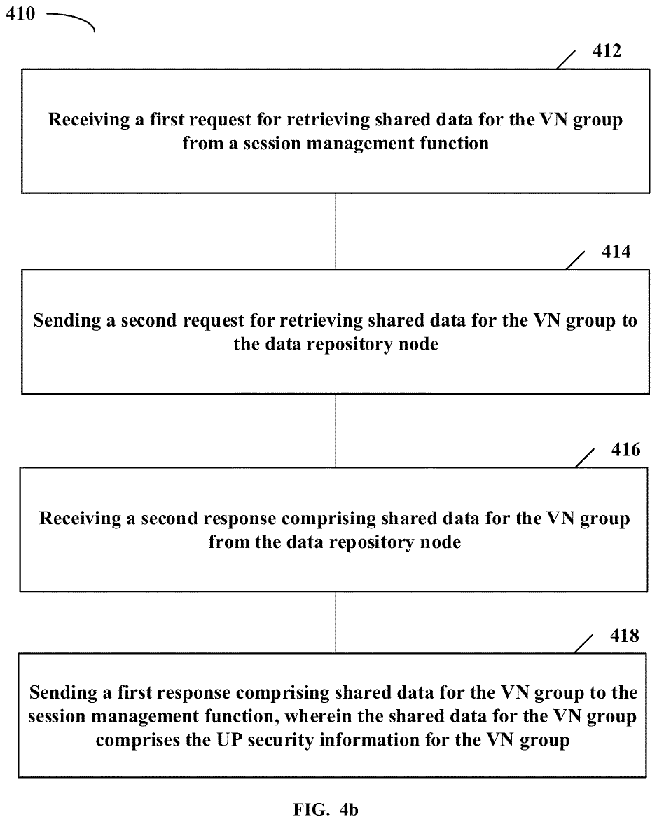

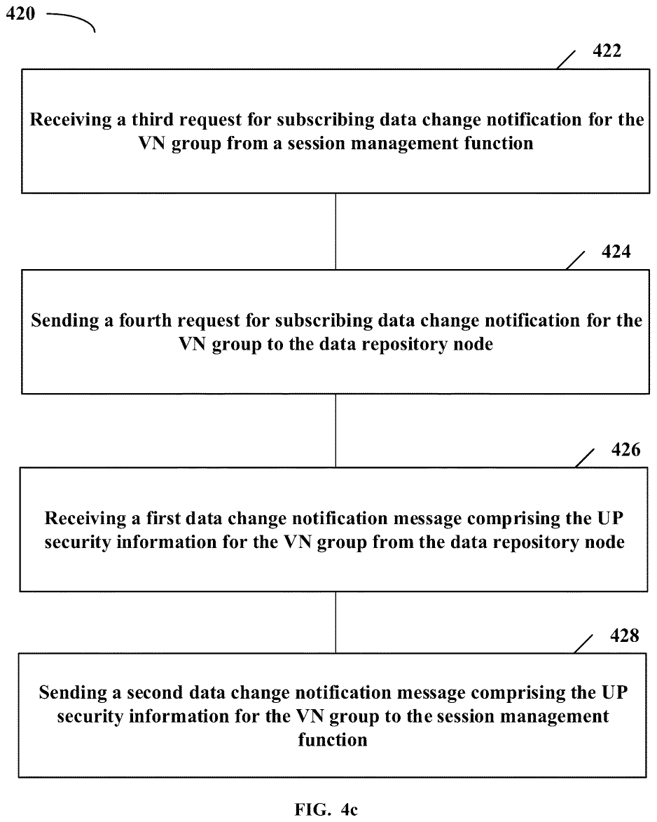

FIG. 2a schematically shows a high level architecture in the fifth generation network according to an embodiment of the present disclosure. For example, the fifth generation network may be 5GS. The architecture of FIG. 2a is same as FIG. 4.2.3-1 as described in 3GPP TS 23.501 V17.5.0, the disclosure of which is incorporated by reference herein in its entirety. The system architecture of FIG. 2a may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), Edge Application Server Discovery Function (EASDF), etc.

In accordance with an exemplary embodiment, the UE can establish a signaling connection with the AMF over the reference point N1, as illustrated in FIG. 2a. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 2a, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 2a also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2a may be responsible for functions such as session management, mobility management, authentication, security, etc. The AUSF, AMF, DN, NEF, NRF, NSSF, PCF, SMF, UDM, UPF, AF, UE, (R)AN, SCP, NSACF, EASDF may include the functionality for example as defined in clause 6.2 of 3GPP TS 23.501 V17.5.0.

FIG. 2b schematically shows system architecture in a 4G network according to an embodiment of the present disclosure, which is the same as FIG. 4.2-1a of 3GPP TS 3GPP TS 23.682 V17.3.0, the disclosure of which is incorporated by reference herein in its entirety. The system architecture of FIG. 2b may comprise some exemplary elements such as Services Capability Server (SCS), Application Server (AS), SCEF (Service Capability Exposure Function), HSS, UE, RAN (Radio Access Network), SGSN (Serving GPRS (General Packet Radio Service) Support Node), MME, MSC (Mobile Switching Centre), S-GW (Serving Gateway), GGSN/P-GW (Gateway GPRS Support Node PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC), IP-SM-GW (Internet protocol Short Message Gateway). The network elements and interfaces as shown in FIG. 2b may be same as the corresponding network elements and interfaces as described in 3GPP TS 3GPP TS 23.682 V17.3.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 2b, the exemplary system architecture also contains various reference points.
Tsms: Reference point used by an entity outside the 3GPP network to communicate with UEs used for MTC via SMS (Short Message Service).
Tsp: Reference point used by a SCS to communicate with the MTC-IWF related control plane signalling.
T4: Reference point used between MTC-IWF and the SMS-SC in the HPLMN.
T6a: Reference point used between SCEF and serving MME.
T6b: Reference point used between SCEF and serving SGSN.
T8: Reference point used between the SCEF and the SCS/AS.
Som: Reference point used by MTC-IWF to interrogate HSS/HLR (Home Location Register).
Son: Reference point used by MTC-AAA to interrogate HSS/HLR.
S6t: Reference point used between SCEF and HSS.
SGs: Reference point used between MSC and MME.
Gi/SGi: Reference point used between GGSN/P-GW and application server and between GGSN/P-GW and SCS.
Rf/Ga: Reference point used between MTC-IWF and CDF/CGF.
Gd: Reference point used between SMS-SC/GMSC/IWMSC and SGSN.
SGd: Reference point used between SMS-SC/GMSC/IWMSC and MME.
E: Reference point used between SMS-SC/GMSC/IWMSC and MSC.

The end-to-end communications, between the MTC Application in the UE and the MTC Application in the external network, uses services provided by the 3GPP system, and optionally services provided by a Services Capability Server (SCS).

The MTC Application in the external network is typically hosted by an Application Server (AS) and may make use of an SCS for additional value added services. The 3GPP system provides transport, subscriber management and other communication services including various architectural enhancements motivated by, but not restricted to, MTC (e.g. control plane device triggering).

Different models are foreseen for machine type of traffic in what relates to the communication between the AS and the 3GPP system and based on the provider of the SCS. The different architectural models that are supported by the Architectural Reference Model include the Direct Model, Indirect Model and Hybrid Model as described in 3GPP TS 3GPP TS 23.682 V17.3.0.

FIG. 2c shows non-roaming architecture for Network Exposure Function in reference point representation, which is same as FIG. 4.2.3-5 of 3GPP TS 23.501 V17.5.0.
NOTE 1: Trust domain for NEF is same as Trust domain for SCEF as defined in 3GPP TS 3GPP TS 23.682 V17.3.0.
NOTE 2: 3GPP Interface represents southbound interfaces between NEF and 5GC Network Functions e.g. N29 interface between NEF and SMF, N30 interface between NEF and PCF, etc. All southbound interfaces from NEF are not shown for the sake of simplicity.

N33 is a reference point between NEF and AF. API denotes Application Programming Interface.

FIG. 2d shows non-roaming Service Exposure Architecture for EPC (Evolved Packet Core)-5GC Interworking, which is same as FIG. 4.3.5.1 1 of 3GPP TS 23.501 V17.5.0. If the UE is capable of mobility between EPS and 5GS, the network is expected to associate the UE with an SCEF+NEF (SCEF combined with NEF) node for Service Capability Exposure.
NOTE 1: Trust domain for SCEF+NEF is same as Trust domain for SCEF as defined in 3GPP TS 3GPP TS 23.682 V17.3.0.
NOTE 2: EPC Interface represents southbound interfaces between SCEF and EPC nodes e.g. the Sot interface between SCEF and HISS, the Toa interface between SCEF and MME, etc. All southbound interfaces from SCEF are defined in 3GPP TS 3GPP TS 23.682 V17.3.0] and are not shown for the sake of simplicity.
NOTE 3: 5GC Interface represents southbound interfaces between NEF and 5GC Network Functions e.g. N29 interface between NEF and SMF, N30 interface between NEF and PCF, etc. All southbound interfaces from NEF are not shown for the sake of simplicity.
NOTE 4: Interaction between the SCEF and NEF within the combined SCEF+NEF is required. For example, when the SCEF+NEF supports monitoring APIs, the SCEF and NEF need to share context and state information on a UE's configured monitoring events if the UE moves between from EPC and 5GC.
NOTE 5: The north-bound APIs which can be supported by an EPC or 5GC network are discovered by the SCEF+NEF node via the CAPIF (Common API Framework for 3GPP northbound APIs) function and/or via local configuration of the SCEF+NEF node. Different sets of APIs can be supported by the two network types.

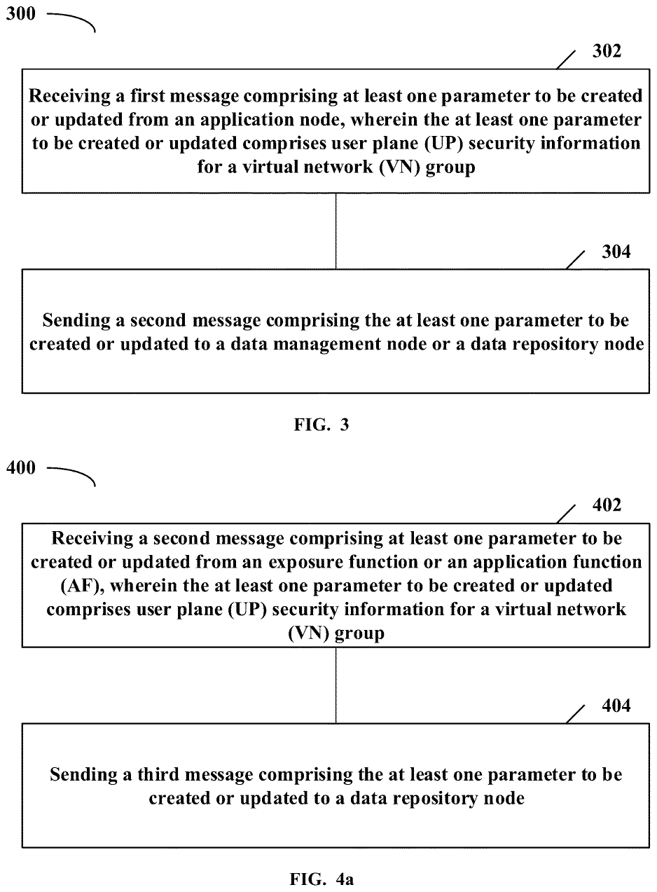

FIG. 3 shows a flowchart of a method according to an embodiment of the present disclosure, which may be performed by an apparatus implemented in or at or as an exposure function or communicatively coupled to the exposure function. As such, the apparatus may provide means or modules for accomplishing various parts of the method 300 as well as means or modules for accomplishing other processes in conjunction with other components.

The exposure function may be any suitable network device or node or entity or function. For example, the exposure function may provide a means to securely expose the services, events and capabilities provided by network interfaces. The exposure function may provide a means for the discovery of the exposed services and capabilities. The exposure function may provide access to network capabilities through homogenous network application programming interfaces (e.g. Network APIs). The exposure function may abstract the services from the underlying network interfaces and protocols. In an embodiment, the network function may comprise at least one of a Service Capability Exposure Function (SCEF), a Network Exposure Function (NEF), a SCEF combined with NEF.

At block 302, the exposure function may receive a first message comprising at least one parameter to be created or updated from an application node. The at least one parameter to be created or updated may comprise user plane (UP) security information for a virtual network (VN) group.

The application node may be any suitable network device or node or entity or function. In an embodiment, the application node may comprise at least one of an application function (AF), a services capability server (SCS), or an application server (AS).

The first message may be any suitable message such as an existing message or a new message. In an embodiment, the first message may comprise at least one of a parameter provision create request or a parameter provision update request. For example, the first message may be Nnef_ParameterProvision_Create request or Nnef_ParameterProvision_Update request as described in 3GPP TS 23.502 V17.5.0.

The at least one parameter to be created or updated may further comprise any suitable parameters. For example, when the first message is a parameter provision create request, it may comprise at least one of AF Identifier, Transaction Reference ID (identifier), GPSI (Generic Public Subscription Identifier) or UE addressing information, External Group ID for 5G VN group creation or for multicast MBS (Multicast/Broadcast Service) group creation, External Group ID, 5G VN group related information (e.g. 5G VN group data, 5G VN membership management), MTC Provider Information, Multicast MBS group related information (e.g. Multicast MBS group membership management), etc.

For example, when the first message is a parameter provision update request, it may comprise at least one of AF Identifier, Transaction Reference ID, GPSI or UE addressing information, External Group ID at least one of the Expected UE Behavior parameters or at least one of the Network Configuration parameters or 5G VN related information or ECS (Edge Configuration Server) Address Configuration Information, Validity Time or Location Privacy Indication parameters, MTC Provider Information, or Multicast MBS group related information.

The VN group may be a set of UEs using private communication for LAN-type service. In an embodiment, the VN group may comprise fifth generation VN group.

The UP security information for a VN group may provision the same user plane security configuration data for the VN group. In an embodiment, the UP security information for the VN group indicates same UP security is applied for the VN group.

The UP security information for a VN group may comprise any suitable user plane security configuration data. In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

At block 304, the exposure function may send a second message comprising the at least one parameter to be created or updated to a data management node or a data repository node.

The data management node may be any suitable network device or node or entity or function. In an embodiment, the data management node may comprise a unified data management (UDM).

The data repository node may be any suitable network device or node or entity or function. In an embodiment, the data repository node may comprise a home subscriber server (HSS) or a home location register (HLR).

The second message may be any suitable message such as an existing message or a new message. In an embodiment, the second message may comprise at least one of a parameter provision create request or a parameter provision update request. For example, the second message may be Nudm_ParameterProvision_Create request or Nudm_ParameterProvision_Update request as described in 3GPP TS 23.502 V17.5.0.

FIG. 4a shows a flowchart of a method according to another embodiment of the present disclosure, which may be performed by an apparatus implemented in or at or as a data management node or communicatively coupled to the data management node. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the data management node may receive a second message comprising at least one parameter to be created or updated from an exposure function or an application function (AF). The at least one parameter to be created or updated may comprise user plane (UP) security information for a virtual network (VN) group.

In an embodiment, the data management node may comprise a unified data management (UDM).

In an embodiment, the exposure function may comprise a network exposure function (NEF).

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the second message may comprise at least one of a parameter provision create request, or a parameter provision update request.

At block 404, the data management node may send a third message comprising the at least one parameter to be created or updated to a data repository node.

The third message may be any suitable message such as an existing message or a new message. In an embodiment, the third message may comprise at least one of a data management create request or a data management update request. For example, the second message may be Nudr_DM_Create request or Nudr_DM_Update request as described in 3GPP TS 23.502 V17.5.0.

In an embodiment, the data repository node may comprise a unified data repository (UDR).

FIG. 4b shows a flowchart of a method according to another embodiment of the present disclosure, which may be performed by an apparatus implemented in or at or as a data management node or communicatively coupled to the data management node. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, the data management node may receive a first request for retrieving shared data for the VN group from a session management function.

The session management function may be any suitable network device or node or entity or function. In an embodiment, the session management function may be SMF.

The first request may be any suitable message such as an existing message or a new message. In an embodiment, the first request may be Nudm_SDM_GET request as described in 3GPP TS 23.502 V17.5.0.

At block 414, the data management node may send a second request for retrieving shared data for the VN group to the data repository node.

The second request may be any suitable message such as an existing message or a new message. In an embodiment, the second request may be Nudr_DM_Query request as described in 3GPP TS 23.502 V17.5.0.

At block 416, the data management node may receive a second response comprising shared data for the VN group from the data repository node.

In an embodiment, the shared data for the VN group may comprise the UP security information for the VN group.

The second response may be any suitable message such as an existing message or a new message. In an embodiment, the second request may be Nudr_DM_Query response as described in 3GPP TS 23.502 V17.5.0.

At block 418, the data management node may send a first response comprising shared data for the VN group to the session management function.

The first response may be any suitable message such as an existing message or a new message. In an embodiment, the first response may be Nudm_SDM_GET response as described in 3GPP TS 23.502 V17.5.0.

FIG. 4c shows a flowchart of a method according to another embodiment of the present disclosure, which may be performed by an apparatus implemented in or at or as a data management node or communicatively coupled to the data management node. As such, the apparatus may provide means or modules for accomplishing various parts of the method 420 as well as means or modules for accomplishing other processes in conjunction with other components. For some parts which have been described in the above embodiments, the description thereof is omitted here for brevity.

At block 422, the data management node may receive a third request for subscribing data change notification for the VN group from a session management function.

The third request may be any suitable message such as an existing message or a new message. In an embodiment, the third request may be Nudm_SDM_Subscribe request as described in 3GPP TS 23.502 V17.5.0.

At block 424, the data management node may send a fourth request for subscribing data change notification for the VN group to the data repository node.

The fourth request may be any suitable message such as an existing message or a new message. In an embodiment, the fourth request may be Nudr_DM_Subscribe request as described in 3GPP TS 23.502 V17.5.0.

At block 426, the data management node may receive a first data change notification message comprising the UP security information for the VN group from the data repository node.

The first data change notification message may be any suitable message such as an existing message or a new message. In an embodiment, the first data change notification message may be Nudr_DM_Notify message as described in 3GPP TS 23.502 V17.5.0.

At block 428, the data management node may send a second data change notification message comprising the UP security information for the VN group to the session management function.

The second data change notification message may be any suitable message such as an existing message or a new message. In an embodiment, the second data change notification message may be Nudm_SDM_Notification message as described in 3GPP TS 23.502 V17.5.0.

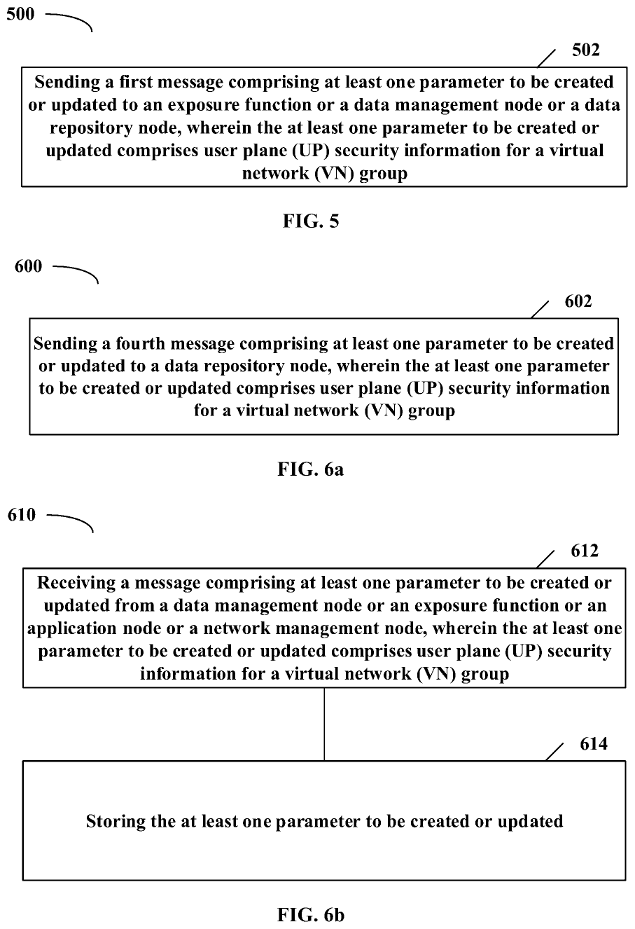

FIG. 5 shows a flowchart of a method according to another embodiment of the present disclosure, which may be performed by an apparatus implemented in or at or as an application node or communicatively coupled to the application node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the application node may send a first message comprising at least one parameter to be created or updated to an exposure function or a data management node or a data repository node. The at least one parameter to be created or updated may comprise user plane (UP) security information for a virtual network (VN) group.

For example, when the application node is a trusted application node, the application node may send the first message to the data management node or the data repository node. When the application node is a untrusted application node, the application node may send the first message to the exposure function.

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the first message may comprise at least one of a parameter provision create request, or a parameter provision update request.

In an embodiment, the application node may comprise at least one of an application function (AF), a services capability server (SCS), or an application server (AS).

In an embodiment, the exposure function may comprise at least one of a service capability exposure function (SCEF), a network exposure function (NEF), or a SCEF combined with NEF.

In an embodiment, the data repository node may comprise at least one of a home subscriber server (HSS), or a home location register (HLR).

In an embodiment, the data management node may comprise a unified data management (UDM).

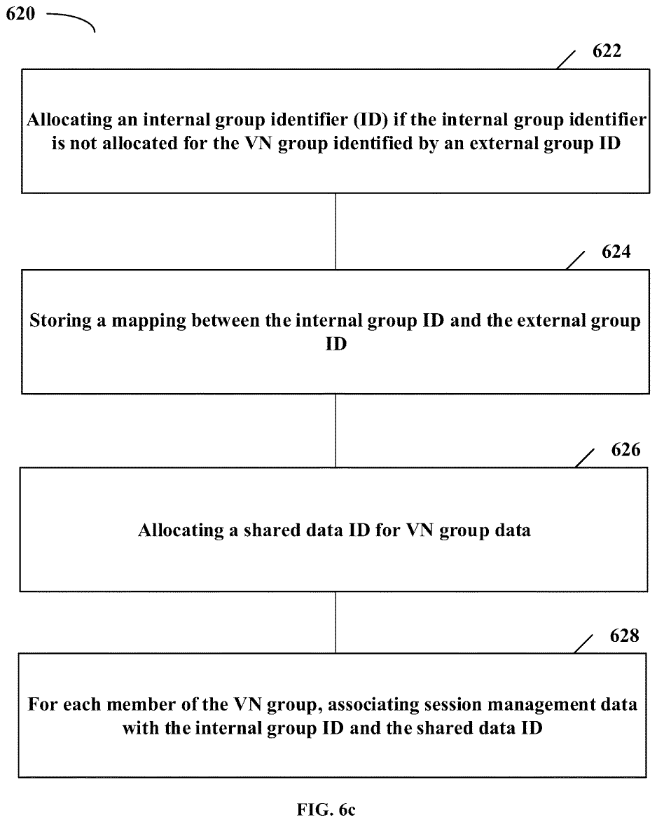

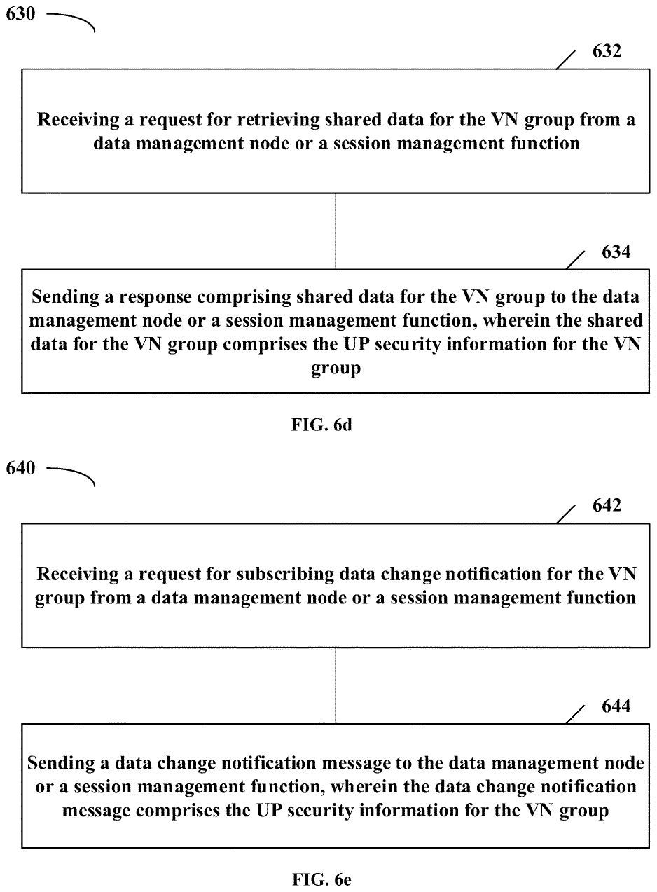

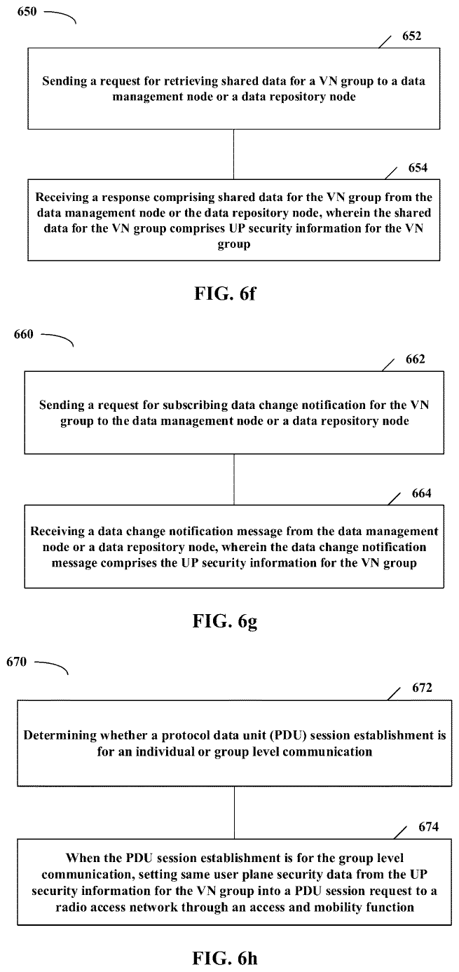

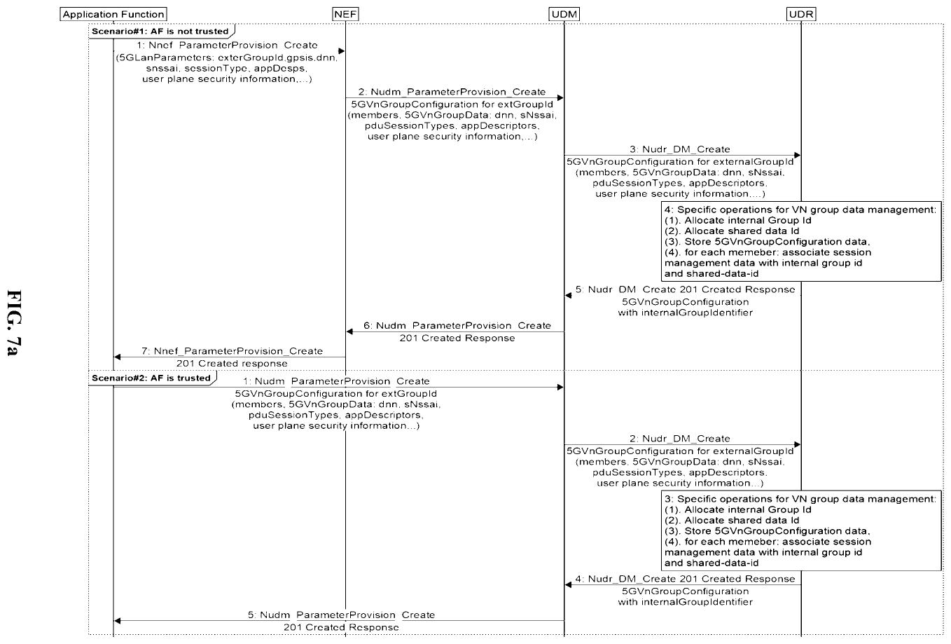

FIG. 6a shows a flowchart of a method according to another embodiment of the present disclosure, which may be performed by an apparatus implemented in or at or as a network management node or communicatively coupled to the network management node. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the network management node may send a fourth message comprising at least one parameter to be created or updated to a data repository node. The at least one parameter to be created or updated may comprise user plane (UP) security information for a virtual network (VN) group.

The network management node may be any suitable network device or node or entity or function. In an embodiment, the network management node may comprise a Communications Service Provider (CSP) provisioning system.

The fourth message may be any suitable message such as an existing message or a new message. In an embodiment, the fourth message may be a parameter provision create request, or a parameter provision update request. For example, the fourth message may be Nudr_DM_Create request or Nudr_DM_Update request as described in 3GPP TS 23.502 V17.5.0. In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the data repository node may comprise a unified data repository (UDR) or a home subscriber server (HSS) or a home location register (HLR).

FIG. 6b shows a flowchart of a method according to another embodiment of the present disclosure, which may be performed by an apparatus implemented in or at or as a data repository node or communicatively coupled to the data repository node. As such, the apparatus may provide means or modules for accomplishing various parts of the method 610 as well as means or modules for accomplishing other processes in conjunction with other components. For some parts which have been described in the above embodiments, the description thereof is omitted here for brevity.

At block 612, the data repository node may receive a message comprising at least one parameter to be created or updated from a data management node or an exposure function or an application node or a network management node. The at least one parameter to be created or updated may comprise user plane (UP) security information for a virtual network (VN) group. At block 614, the data repository node may store the at least one parameter to be

created or updated.

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the message may comprise at least one of a data management create request, or a data management update request.

In an embodiment, the data repository node may comprise at least one of a home subscriber server (HSS), a home location register (HLR), or a unified data repository (UDR).

In an embodiment, the data management node may comprise a unified data management (UDM).

In an embodiment, the exposure function may comprise at least one of a service capability exposure function (SCEF), a network exposure function (NEF), or a SCEF combined with NEF.

In an embodiment, the application node may comprise at least one of an application function (AF), a services capability server (SCS), or an application server (AS).

In an embodiment, the network management node may comprise a CSP provisioning system.

FIG. 6c shows a flowchart of a method according to another embodiment of the present disclosure, which may be performed by an apparatus implemented in or at or as a data repository node or communicatively coupled to the data repository node. As such, the apparatus may provide means or modules for accomplishing various parts of the method 620 as well as means or modules for accomplishing other processes in conjunction with other components. For some parts which have been described in the above embodiments, the description thereof is omitted here for brevity.

At block 622, the data repository node may allocate an internal group identifier (ID) if the internal group identifier is not allocated for the VN group identified by an external group ID.

At block 624, the data repository node may store a mapping between the internal group ID and the external group ID.

At block 626, the data repository node may allocate a shared data ID for VN group data.

At block 628, for each member of the VN group, the data repository node may associate session management data with the internal group ID and the shared data ID.

FIG. 6d shows a flowchart of a method according to another embodiment of the present disclosure, which may be performed by an apparatus implemented in or at or as a data repository node or communicatively coupled to the data repository node. As such, the apparatus may provide means or modules for accomplishing various parts of the method 630 as well as means or modules for accomplishing other processes in conjunction with other components. For some parts which have been described in the above embodiments, the description thereof is omitted here for brevity.

At block 632, the data repository node may receive a request for retrieving shared data for the VN group from a data management node or a session management function.

At block 634, the data repository node may send a response comprising shared data for the VN group to the data management node or a session management function.

In an embodiment, the shared data for the VN group may comprise the UP security information for the VN group.

FIG. 6c shows a flowchart of a method according to another embodiment of the present disclosure, which may be performed by an apparatus implemented in or at or as a data repository node or communicatively coupled to the data repository node. As such, the apparatus may provide means or modules for accomplishing various parts of the method 640 as well as means or modules for accomplishing other processes in conjunction with other components. For some parts which have been described in the above embodiments, the description thereof is omitted here for brevity.

At block 642, the data repository node may receive a request for subscribing data change notification for the VN group from a data management node or a session management function.

At block 644, the data repository node may send a data change notification message to the data management node or a session management function.

In an embodiment, the data change notification message may comprise the UP security information for the VN group.

FIG. 6f shows a flowchart of a method according to another embodiment of the present disclosure, which may be performed by an apparatus implemented in or at or as a session management function or communicatively coupled to the session management function. As such, the apparatus may provide means or modules for accomplishing various parts of the method 650 as well as means or modules for accomplishing other processes in conjunction with other components. For some parts which have been described in the above embodiments, the description thereof is omitted here for brevity.

At block 652, the session management function may send a request for retrieving shared data for a VN group to a data management node or a data repository node.

At block 654, the session management function may receive a response comprising shared data for the VN group from the data management node or the data repository node.

In an embodiment, the shared data for the VN group may comprise UP security information for the VN group.

In an embodiment, the VN group may comprise fifth generation VN group.

In an embodiment, the UP security information for the VN group indicates same UP security is applied for the VN group.

In an embodiment, the UP security information for the VN group may comprise at least one of an information element indicating whether UP integrity protection is required, preferred or not needed for traffic on a protocol data unit (PDU) session, or an information element indicating whether UP confidentiality protection is required, preferred or not needed for traffic on a PDU session.

In an embodiment, the data repository node may comprise at least one of a home subscriber server (HSS), or a home location register (HLR).

In an embodiment, the data management node may comprise a unified data management (UDM).

FIG. 6g shows a flowchart of a method according to another embodiment of the present disclosure, which may be performed by an apparatus implemented in or at or as a session management function or communicatively coupled to the session management function. As such, the apparatus may provide means or modules for accomplishing various parts of the method 660 as well as means or modules for accomplishing other processes in conjunction with other components. For some parts which have been described in the above embodiments, the description thereof is omitted here for brevity.

At block 662, the session management function may send a request for subscribing data change notification for the VN group to the data management node or a data repository node.

At block 664, the session management function may receive a data change notification message from the data management node or a data repository node.

In an embodiment, the data change notification message may comprise the UP security information for the VN group.

FIG. 6h shows a flowchart of a method according to another embodiment of the present disclosure, which may be performed by an apparatus implemented in or at or as a session management function or communicatively coupled to the session management function. As such, the apparatus may provide means or modules for accomplishing various parts of the method 670 as well as means or modules for accomplishing other processes in conjunction with other components. For some parts which have been described in the above embodiments, the description thereof is omitted here for brevity.

At block 672, the session management function may determine whether a protocol data unit (PDU) session establishment is for an individual or group level communication.

The session management function may determine whether a PDU session establishment is for an individual or group level communication in various ways. For example, the SMF may receive an Nsmf_PDUSession_CreateSMContext Request from the AMF as described in 3GPP TS 23.502 V17.5.0, the Nsmf_PDUSession_CreateSMContext Request may comprise information indicating whether a PDU session establishment is for an individual or group level communication. The session management function may determine whether a PDU session establishment is for an individual or group level communication based on subscription information or any other suitable information.

For example, the SMF may determine whether the PDU session establishment is for an individual or group level communication, for example based on DNN (Data Network Name) and S-NSSAI (Single Network Slice Selection Assistance Information) information, and further determines the user plane security should be used.

At block 674, when the PDU session establishment is for the group level communication, the session management function may set same user plane security data from the UP security information for the VN group into a PDU session request to a radio access network through an access and mobility function.

In an embodiment, a User Plane Security Enforcement information for the user plane of a PDU session may be determined based on at least one of:
subscribed User Plane Security configuration which is part of SM subscription information received from UDM; and
User Plane Security configuration locally configured per (DNN, S-NSSAI) in the SMF that is used when the UDM does not provide User Plane Security configuration information.

Once determined at the establishment of the PDU Session, the User Plane Security Enforcement information applies for the life time of the PDU Session.

In an embodiment, User Plane Security configuration from UDM takes precedence over locally configured User Plane Security configuration. It is responsibility of the NG-RAN to enforce that the maximum UP integrity protection data rate delivered to the UE in downlink is not exceeding the maximum supported data rate for integrity protection.

In an embodiment, the User Plane Security information (later annotated as UpSecurity data type in the protocol extension) provides the NG-RAN with User Plane (UP) security policies for a PDU session.

In an embodiment, the User Plane Security information indicates whether UP integrity protection is (later annotated as UpIntegrity data type in the protocol extension):
Required: for all the traffic on the PDU Session UP integrity protection shall apply.
Preferred: for all the traffic on the PDU Session UP integrity protection should apply.
Not Needed: UP integrity protection shall not apply on the PDU Session.

In an embodiment, the User Plane Security information indicates whether UP confidentiality protection is (later annotated as UpConfidentiality Data type in the protocol extension):
Required: for all the traffic on the PDU Session UP confidentiality protection shall apply.
Preferred: for all the traffic on the PDU Session UP confidentiality protection should apply.
Not Needed: UP confidentiality shall not apply on the PDU Session.

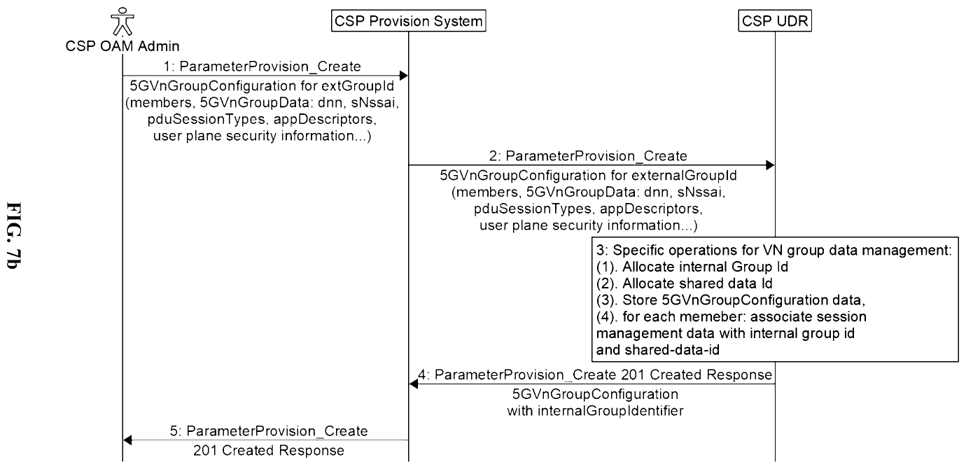

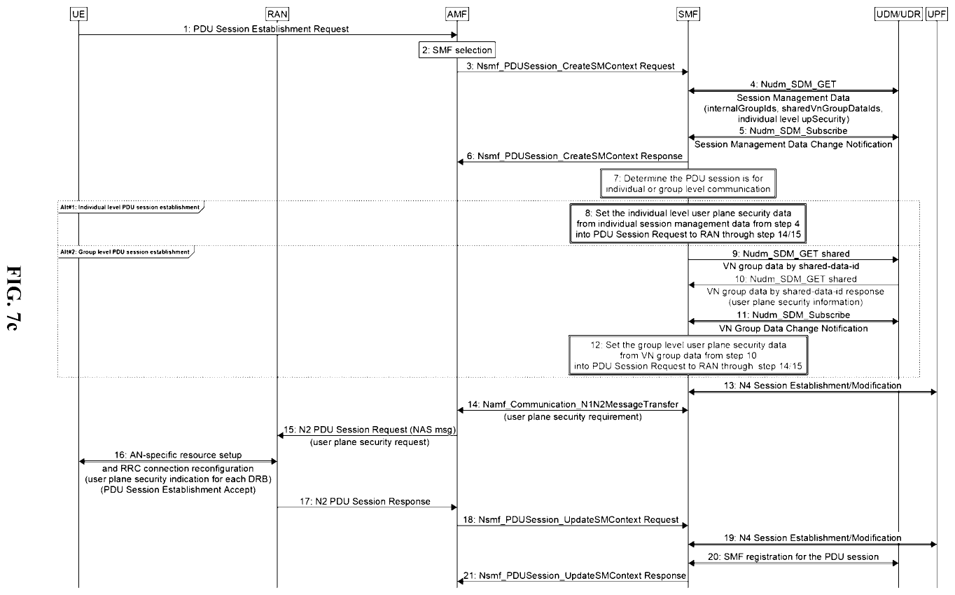

FIG. 7a shows a flowchart of AF provision user plane configuration data for a VN Group according to an embodiment of the present disclosure.

The flowchart depicts the call flow for AF provision user plane security information for a VN Group. Two scenarios are included.

For scenario 1, AF is from external application function or from external enterprise application or from external vertical industry application, so AF is not trusted from CSP's network, the steps may be as following.

At step 1. AF may initiate an HTTP (Hyper Text Transfer Protocol) POST request to the NEF for the “5GLAN Parameters Provision Subscriptions” resource. The body of the HTTP POST message shall include the 5G LAN service-related parameters within the “5gLanParams” attribute. Here the novel part is that 5GLanParameters is extended with a new attribute in order to provision the same user plane security configuration data.

One embodiment of the 5GLanParameters protocol payload extended (highlighted part is the extension) with user plane security is as below in Table 1.

TABLE 1
Definition of type 5GLanParameters extended with new upSecurity attribute

| Attribute name | Data type | P | Cardinality | Description | Applicability |
|---|---|---|---|---|---|
| exterGroupId | ExternalGroupId | M | 1 | Identifies an 5G Virtual | |
| | | | | Network Group. | |
| gpsis | map(Gpsi) | M | 1 . . . N | Represents the list of 5G | |
| | | | | VN Group members, | |
| | | | | each member is identified | |
| | | | | by GPSI. | |
| | | | | Any string value can be | |
| | | | | used as a key of the map. | |
| dnn | Dnn | M | 1 | DNN for the 5G VN | |
| | | | | group, a full DNN with | |
| | | | | both the Network | |
| | | | | Identifier and Operator | |
| | | | | Identifier, or a DNN with | |
| | | | | the Network Identifier | |
| | | | | only. | |
| aaaIpv4Addr | Ipv4Addr | O | 1 | Identifies the DN-AAA | |
| | | | | server IPv4 address | |
| | | | | provided by AF, for the | |
| | | | | secondary authentication/ | |
| | | | | authorization | |
| | | | | and/or UE IP address | |
| | | | | allocation by DN-AAA | |
| | | | | server. | |
| aaaIpv6Addr | Ipv6Addr | O | 1 | Identifies the DN-AAA | |
| | | | | server IPv6 address | |
| | | | | provided by AF, for the | |
| | | | | secondary authentication/ | |
| | | | | authorization | |
| | | | | and/or UE IP address | |
| | | | | allocation by DN-AAA | |
| | | | | server. | |
| aaaUsgs | array(AaaUsage) | O | 1 . . . 2 | Identifies the usage needs | |
| | | | | for secondary | |
| | | | | authentication/authorization | |
| | | | | and/or UE IP address | |
| | | | | allocation from the | |
| | | | | DN-AAA server. | |
| mtcProviderId | MtcProviderInformation | O | 0 . . . 1 | Indicates MTC provider | |
| | | | | information for 5G VN | |
| | | | | Group Configuration | |
| | | | | authorization. (NOTE 1) | |
| snssai | Snssai | M | 1 | S-NSSAI for the 5G VN | |
| | | | | group. | |
| sessionType | PduSessionType | M | 1 | PDU Session Type | |
| | | | | allowed for 5G VN | |
| | | | | group. | |
| sessionTypes | array(PduSessionType) | O | 1 . . . N | If further PDU Session | multipleSessionTypes |
| | | | | Types (in addition to the | |
| | | | | PDU Session Type | |
| | | | | indicated in the | |
| | | | | “sessionType” attribute) | |
| | | | | are allowed for the 5G | |
| | | | | VN group, they are | |
| | | | | provided in this attribute. | |
| | | | | (NOTE 2) | |
| appDesps | map(AppDescriptor) | M | 1 . . . N | Describes the operation | |
| | | | | systems and the | |
| | | | | corresponding | |
| | | | | applications for each | |
| | | | | operation systems. The | |
| | | | | key of map is osId. | |
| upSecurity | UpSecurity | O | 0 . . . 1 | When present, this IE | |
| | | | | shall indicate the same | |
| | | | | user plane security for | |
| | | | | integrity protection and | |
| | | | | encryption for this 5G | |
| | | | | LAN group. | |

(NOTE 1):
The NEF should check received MTC Provider information and then the NEF may:
override it with local configured value and send it to UDM;
send it directly to the UDM; or
reject the 5G VN Group Configuration request.
(NOTE 2):
Only one PDU Session type is applied for a PDU Session of a VN group at a time.

Table 1 is same as Table 5.7.2.3.3-1 of 3GPP TS 29.522 V17.7.0 in addition to the new attribute “upSecurity”.

In an embodiment, A.5 of 3GPP TS 29.522 V17.7.0 may be amended as following.

### A.5 5GLANPARAMETERPROVISION API

( . . . text not shown for clarity . . . )

```
  5GLanParameters:
    description: Represents 5G LAN service related parameters that need to be provisioned.
    type: object
    properties:
      exterGroupId:
        $ref: ‘TS29122_CommonData.yaml#/components/schemas/ExternalGroupId’
      gpsis:
        type: object
        additionalProperties:
          $ref: ‘TS29571_CommonData.yaml#/components/schemas/Gpsi’
        minProperties: 1
        description: >
          Contains the list of 5G VN Group members, each member is identified by GPSI.
          Any string value can be used as a key of the map.
      dnn:
        $ref: ‘TS29571_CommonData.yaml#/components/schemas/Dnn’
      aaaIpv4Addr:
        $ref: ‘TS29571_CommonData.yaml#/components/schemas/Ipv4Addr’
      aaaIpv6Addr:
        $ref: ‘TS29571_CommonData.yaml#/components/schemas/Ipv6Addr’
      aaaUsgs:
        type: array
        items:
          $ref: ‘#/components/schemas/AaaUsage’
        minItems: 1
      mtcProviderId:
        $ref: ‘TS29571_CommonData.yaml#/components/schemas/MtcProviderInformation’
      snssai:
        $ref: ‘TS29571_CommonData.yaml#/components/schemas/Snssai’
      sessionType:
        $ref: ‘TS29571_CommonData.yaml#/components/schemas/PduSessionType’
      sessionTypes:
        type: array
        items:
          $ref: ‘TS29571_CommonData.yaml#/components/schemas/PduSessionType’
        minItems: 1
        description: Further allowed PDU Session types.
      appDesps:
        type: object
        additionalProperties:
          $ref: ‘#/components/schemas/AppDescriptor’
        minProperties: 1
        description: Describes the operation systems and the corresponding applications for each
operation systems. The key of map is osId.
      upSecurity:
        $ref: ‘TS29571_CommonData.yaml#/components/schemas/UpSecurity’
    required:
      - exterGroupId
      - gpsis
      - dnn
      - snssai
      - sessionType
      - appDesps
```

( . . . text not shown for clarity . . . )

UpSecurity data type is further defined as in Table 2:

TABLE 2
Definition of type UpSecurity

| Attribute name | Data type | P | Cardinality | Description |
|---|---|---|---|---|
| upIntegr | UpIntegrity | M | 1 | This IE shall indicate whether UP integrity |
| | | | | protection is required, preferred or not needed for |
| | | | | all the traffic on the PDU Session. |
| upConfid | UpConfidentiality | M | 1 | This IE shall indicate whether UP confidentiality |
| | | | | protection is required, preferred or not needed for |
| | | | | all the traffic on the PDU Session. |

The enumeration UpIntegrity indicates whether UP integrity protection is required, preferred or not needed for all the traffic on the PDU Session. It may comply with the provisions defined in Table 3.

TABLE 3
Enumeration UpIntegrity

| Enumeration value | Description |
|---|---|
| “REQUIRED” | UP integrity protection shall apply for all the |
| | traffic on the PDU Session. |
| “PREFERRED” | UP integrity protection should apply for all |
| | the traffic on the PDU Session. |
| “NOT_NEEDED” | UP integrity protection shall not apply on the |
| | PDU Session. |

The enumeration UpConfidentiality indicates whether UP confidentiality protection is required, preferred or not needed for all the traffic on the PDU Session. It may comply with the provisions defined in Table 4.

TABLE 4
Enumeration UpConfidentiality

| Enumeration value | Description |
|---|---|
| “REQUIRED” | UP confidentiality protection shall apply |
| | for all the traffic on the PDU Session. |
| “PREFERRED” | UP confidentiality protection should apply |
| | for all the traffic on the PDU Session. |
| “NOT_NEEDED” | UP confidentiality protection shall not apply |
| | on the PDU Session. |

At step 2. Upon receipt of the corresponding HTTP POST message, if the AF is authorized by the NEF to provision the parameters, the NEF may interact with the UDM to create a subscription at the UDM by using Nudm_ParameterProvision service. NEF may send a request to the UDM to create a 5G VN Group. The request contains the group's external identifier and the group configuration. The 5GVnGroupData is extended with a new attribute in order to provision the same user plane security information, for description of the attribute, check the descriptions in Step 1.

One embodiment of the 5GVnGroupData protocol payload extended (highlighted part is the extension) with user plane security is as below in Table 5:

TABLE 5
Definition of type 5GVnGroupData with new extended upSecurity attribute

| Attribute name | Data type | P | Cardinality | Description |
|---|---|---|---|---|
| dnn | Dnn | M | 1 | DNN of the 5G VN group, shall contain the |
| | | | | Network Identifier only. |
| sNssai | Snssai | M | 1 | S-NSSAI of the 5G VN group's |
| | | | | communication session |
| pduSessionTypes | array(PduSessionType) | O | 1 . . . N | List of PDU Session Types allowed for 5G |
| | | | | VN group's communication session |
| appDescriptors | array(AppDescriptor) | O | 1 . . . N | List of Application Descriptors allowed for |
| | | | | 5G VN group's communication session |
| secondaryAuth | boolean | O | 0 . . . 1 | Indicates whether secondary authentication |
| | | | | and authorization is needed. |
| | | | | true: secondary authentication and |
| | | | | authorization is needed. |
| | | | | false: secondary authentication and |
| | | | | authorization is not needed. |
| | | | | If absent, it indicates that secondary |
| | | | | authentication is not required by the NEF, |
| | | | | but it still may be required by local policies |
| | | | | at the SMF. |
| dnAaaIpAddressAllocation | boolean | O | 0 . . . 1 | Indicates whether the SMF is required to |
| | | | | request the UE IP address from the |
| | | | | DN-AAA server for PDU Session |
| | | | | Establishment. |
| | | | | true: required |
| | | | | false: not required |
| | | | | If absent, it indicates that the request by |
| | | | | SMF of the UE IP address from the |
| | | | | DN-AAA server is not required, but it still |
| | | | | may be required by local policies at the |
| | | | | SMF. |
| dnAaaAddress | IpAddress | O | 0 . . . 1 | The IP address of the DN-AAA server, |
| | | | | used for secondary authentication and |
| | | | | authorization. |
| additionalDnAaaAddresses | array(IpAddress) | O | 1 . . . N | Additional IP addresses of the DN-AAA |
| | | | | server used for secondary authentication |
| | | | | and authorization. |
| dnAaaFqdn | Fqdn | O | 0 . . . 1 | The FQDN of the DN-AAA server used for |
| | | | | secondary authentication and authorization. |
| upSecurity | UpSecurity | O | 0 . . . 1 | When present, this IE shall indicate the |
| | | | | same user plane security for integrity |
| | | | | protection and encryption for this 5G LAN |
| | | | | VN group. |

Table 5 is same as Table 6.5.6.2.7-1 of 3GPP TS 29.503 V17.8.0 in addition to the new attribute “upSecurity”.

At step 3. UDM may send a request to the UDR to create a 5G VN Group. The request may contain the group's external identifier and the group configuration. Similarly, the 5GVnGroupConfiguration on Nudr interface is extended with a new attribute in order to provision user plane security information. One embodiment of the 5GVnGroupData protocol payload extended with user plane security configuration is as depicted in step 2.

At step 4. Upon receipt of the corresponding message from UDM to create a 5G VN Group, as an embodiment method, UDR may execute below specific logics:
(1) Store 5GVnGroupConfiguration data with the new extended attribute mentioned above for the same user plane security configuration
(2) Allocate internal Group Id if not allocated by UDM yet for the group identified by the external group identifier, and store the mapping between internal group id and external group Id
(3) Allocate shared data Id for VN Group data
(4) For each member indicated in the 5GVnGroupConfiguration for the VN group: associate the session management data with internal group id and shared-data-id pointing to the VN group data

At step 5. UDR may inform the UDM with a successful response. The internal group identifier may be retuned in the response.

At step 6. UDM may inform the NEF with a successful response.

At step 7. NEF may inform the AF with a successful response.

For scenario 2, AF is trusted, the steps may be as following.

At step 1. AF may send a request to the UDM to create a 5G VN Group. The request may contain the identifier and the group configuration. The 5GVnGroupConfiguration is extended with a new attribute in order to provision the same user plane configuration data: UpIntegrity and UpConfidentiality, for description of those attributes, check the descriptions in Step 1 of scenario 1.

At step 2. UDM may send a request to the UDR to create a 5G VN Group. The request may contain the group's external identifier and the group configuration. Similarly, the 5GVnGroupConfiguration on Nudr interface is extended with a new attribute in order to provision the same user plane security configuration data: UpIntegrity and UpConfidentiality, for description of those attributes, check the descriptions in Step 1 of scenario 1.

At step 3. Upon receipt of the corresponding message from UDM to create a 5G VN Group, UDR may execute specific logics:
(1) Allocate internal Group Id if not allocated by UDM yet for the group identified by the external group identifier, and store the mapping between internal group id and external group Id
(2) Allocate shared data Id for 5G VN Group data
(3) Store 5GVnGroupConfiguration data with the new extended attribute mentioned above for the same user plane security configuration
(4) For each member indicated in the 5GVnGroupConfiguration for the VN group: associate the session management data with internal group id and shared-data-id point to the VN group data

At step 4. UDR may inform the UDM with a successful response. The internal group identifier may be retuned in the response.

At step 5. UDM may inform the AF with a successful response.

FIG. 7b shows a flowchart of CSP provision user plane security data for a VN Group according to an embodiment of the present disclosure.

The flowchart depicts the call flow for CSP provision user plane security through OAM and provisioning system, the steps may be as following.

At step 1. CSP OAM (Operation Administration and Maintenance) administrator may send a parameter provisioning request to the provisioning system to create a 5G VN Group. The request may contain the group's external identifier and the group configuration. The 5GVnGroupConfiguration is extended with a new attribute in order to provision the same user plane security configuration data: UpIntegrity and UpConfidentiality, for description of those attributes, check the descriptions in Step 1 of Scenario 1 of FIG. 7a.

At step 2. The provisioning system may send a request to the UDR to create a 5G VN Group. The request may contain the group's external identifier and the group configuration. Similarly, the 5GVnGroupConfiguration on Nudr interface is extended with a new attribute in order to provision the same user plane configuration data: UpIntegrity and UpConfidentiality, for description of those attributes, check the descriptions in Step 1 of Scenario 1 of FIG. 7a.

At step 3. Upon receipt of the corresponding message from provisioning system to create a 5G VN Group, UDR may execute specific logics:
(1) Allocate internal Group Id for the group identified by the external group identifier, and store the mapping between internal group id and external group Id
(2) Allocate shared data Id for 5G VN Group data
(3) Store 5GVnGroupConfiguration data with the new extended attribute mentioned above for the same user plane security configuration
(4) For each member indicated in the 5GVnGroupConfiguration for the VN group: associate the session management data with internal group id and shared-data-id point to the VN group data

At step 4. UDR may inform the provisioning system with a successful response.

At step 5. The provisioning system may inform the OAM administrator with a successful response.

FIG. 7c shows a flowchart of PDU session establishment procedure according to an embodiment of the present disclosure.

The flowchart depicts PDU session establishment/modification procedure. For group level PDU sessions, the provisioned shared VN group data may be retrieved from UDM. Based on the embodiments of the present disclosure, the VN group data is extended with user plane security data. The steps are as following.

At step 1. The UE initiates the UE Requested PDU Session Establishment procedure by the transmission of a NAS message containing a PDU Session Establishment Request within the N1 SM (session management) container. The PDU Session Establishment Request includes a PDU session ID, Requested PDU Session Type, a Requested SSC (Session and Service Continuity) mode, 5GSM Capability, PCO (Protocol Configuration Options), SM PDU DN Request Container, [Number Of Packet Filters], [Header Compression Configuration], UE Integrity Protection Maximum Data Rate, [Always-on PDU Session Requested], [RSN (Redundancy Sequence Number)] and [PDU Session Pair ID].

At step 2. The AMF selects an SMF.

At step 3. If the AMF does not have an association with an SMF for the PDU Session ID provided by the UE (e.g. when Request Type indicates “initial request”), the AMF invokes the Nsmf_PDUSession_CreateSMContext Request, but if the AMF already has an association with an SMF for the PDU Session ID provided by the UE (e.g. when Request Type indicates “existing PDU Session”), the AMF invokes the Nsmf_PDUSession_UpdateSMContext Request.

At step 4. If Session Management Subscription data for corresponding SUPI, DNN and S-NSSAI of the HPLMN is not available, then SMF retrieves the Session Management Subscription data using Nudm_SDM_Get (SUPI, Session Management Subscription data, selected DNN, S-NSSAI of the HPLMN, Serving PLMN ID, [NID]).

UDR sends UDM with the session management subscription data for the UE. The UDR allocated internal group Id the UE belongs to is returned, meanwhile a shared data id pointing to the VN Group data is also returned, UDM further sends the session management data to SMF.

At step 5. SMF subscribes to be notified when this subscription data is modified using Nudm_SDM_Subscribe (SUPI, Session Management Subscription data, selected DNN, S-NSSAI of the HPLMN, Serving PLMN ID, [NID]). UDM may get this information from UDR by Nudr_DM_Query (SUPI, Subscription Data, Session Management Subscription data, selected DNN, S-NSSAI of the HPLMN, Serving PLMN ID, [NID]) and may subscribe to notifications from UDR for the same data by Nudr_DM_subscribe.

SMF supports VN group data handling could indicate its support of SharedData feature to UDM.

At step 6. SMF sends AMF the Nsmf_PDUSession_CreateSMContext response.

At step 7. The SMF determines whether the PDU session establishment is for an individual or group level communication, for example based on DNN and S-NSSAI information, and further determines the user plane security should be used.

A User Plane Security Enforcement information for the user plane of a PDU session based on:
subscribed User Plane Security configuration which is part of SM subscription information received from UDM; and
User Plane Security configuration locally configured per (DNN, S-NSSAI) in the SMF that is used when the UDM does not provide User Plane Security configuration information.

Once determined at the establishment of the PDU Session the User Plane Security Enforcement information applies for the life time of the PDU Session.

User Plane Security configuration from UDM takes precedence over locally configured User Plane Security configuration. It is responsibility of the NG-RAN to enforce that the maximum UP integrity protection data rate delivered to the UE in downlink is not exceeding the maximum supported data rate for integrity protection.

It is expected that generally the UP integrity protection data rate applied by the UE in uplink will not exceed the indicated maximum supported data rate, but the UE is not required to perform strict rate enforcement.

User Plane Security Enforcement information and the maximum supported data rate per UE for integrity protection is communicated from source to target NG-RAN node at handover. If the target RAN node cannot support requirements in User Plane Security Enforcement information, the target RAN node rejects the request to setup resources for the PDU Session. In this case the PDU Session is not handed over to the target RAN node and the PDU Session is released.

Alt #1: if the PDU session establishment is for an individual communication

At step 8. SMF checks individual level user plane security information from the session management data received from step 4 and if the PDU session establishment is for an individual communication, set the user plane security data from individual session management data into PDU session request to RAN through AMF in step 14 and step 15

Alt #2: if the PDU session establishment is for a group level communication

At step 9. SMF checks the received session management data and finds that the UE belongs to a group identified by the internal group id and associated shared data id for the VN group data, SMF retrieves the shared data for the VN group by shared data id from UDM, UDM further retrieve it from UDR

At step 10. UDR sends UDM the shared data for the VN group, as discussed before, user plane security configuration for the VN group also returned in the VN group data, UDM further sends the VN group data with user plane security configuration contained to SMF

One embodiment of the shared VnGroupData extended (underlined part is the extension) with user plane security configuration is as below in Table 6.

TABLE 6
Definition of type VnGroupData with new extended upSecurity attibute

| Attribute name | Data type | P | Cardinality | Description |
|---|---|---|---|---|
| pduSessionTypes | PduSessionTypes | O | 0 . . . 1 | Allowed session types |
| dnn | Dnn | O | 0 . . . 1 | Data Network Name with Network |
| | | | | Identifier only. (NOTE) |
| singleNssai | Snssai | O | 0 . . . 1 | Single Nssai |
| appDescriptors | array(AppDescriptor) | O | 1 . . . N | List of Application Descriptors |
| upSecurity | UpSecurity | O | 1 . . . N | When present, this IE shall indicate the |
| | | | | same user plane security for integrity |
| | | | | protection and encryption for this 5G |
| | | | | LAN VN group |

(NOTE):
Only a 1:1 mapping between DNN and 5G VN group is supported in this release

Table 6 is same as Table 6.1.6.2.39-1 of 3GPP TS 29.503 V17.8.0 in addition to the new attribute “upSecurity”.

In an embodiment, A.2 of 3GPP TS 29.503 V17.8.0 may be amended as following.

### A.2 NUDM_SDM API

( . . . text not shown for clarity . . . )

```
VnGroupData:
  type: object
  properties:
    pduSessionTypes:
      $ref: ‘#/components/schemas/PduSessionTypes’
    dnn:
      $ref: ‘TS29571_CommonData.yaml#/components/schemas/Dnn’
    singleNssai:
      $ref: ‘TS29571_CommonData.yaml#/components/schemas/Snssai’
    appDescriptors:
      type: array
      items:
        $ref: ‘#/components/schemas/AppDescriptor’
      minItems: 1
    upSecurity:
      $ref:
      ‘TS29571_CommonData.yaml#/components/schemas/UpSecurity’
```

( . . . text not shown for clarity . . . )

In an embodiment, A.6 of 3GPP TS 29.503 V17.8.0 may be amended as following.

### A.6 NUDM_PP API

( . . . text not shown for clarity . . . )

```
5GVnGroupData:
  type: object
  required:
    - dnn
    - sNssai
  properties:
    dnn:
      $ref: ‘TS29571_CommonData.yaml#/components/schemas/Dnn’
    sNssai:
      $ref: ‘TS29571_CommonData.yaml#/components/schemas/Snssai’
    pduSessionTypes:
      type: array
      items:
        $ref: ‘TS29571_CommonData.yaml#/components/schemas/PduSessionType’
      minItems: 1
    appDescriptors:
      type: array
      items:
        $ref: ‘TS29503_Nudm_SDM.yaml#/components/schemas/AppDescriptor’
      minItems: 1
    secondaryAuth:
      type: boolean
    dnAaaIpAddressAllocation:
      type: boolean
    dnAaaAddress:
      $ref: ‘TS29503_Nudm_SDM.yaml#/components/schemas/IpAddress’
    additionalDnAaaAddresses:
      type: array
      items:
        $ref: ‘TS29503_Nudm_SDM.yaml#/components/schemas/IpAddress’
      minItems: 1
    dnAaaFqdn:
      $ref: ‘TS29571_CommonData.yaml#/components/schemas/Fqdn’
    upSecurity:
      $ref: ‘TS29571_CommonData.yaml#/components/schemas/UpSecurity’
```

( . . . text not shown for clarity . . . )

NOTE: UpSecurity is as defined in Tables 2-4.

At step 11. SMF may subscribe the data change notification for VN group data through UDM to UDR, if there are user plane security changes, the changed user plane security will be notified to SMF, so SMF can keep informed of the user plane security configuration changes for the VN group

At step 12. SMF checks group level user plane security information from the VN group data received from step 10 and if the PDU session establishment is for an group level communication, set the same user plane security data from VN group data into PDU session request to RAN through AMF in step 14 and step 15

At step 13. SMF sends UPF the N4/PFCP session establishment/modification message including the PDR, FAR and other rules for the PDU session, UPF process the session establish/modification request, create the rules provided by SMF

At step 14. SMF to AMF: Namf_Communication_NIN2MessageTransfer (PDU Session ID, N2 SM information (PDU Session ID, QFI(s), QoS Profile(s), CN Tunnel Info, S-NSSAI from the Allowed NSSAI, Session-AMBR, PDU Session Type, User Plane Security Enforcement information, UE Integrity Protection Maximum Data Rate, RSN, PDU Session Pair ID), N1 SM container (PDU Session Establishment Accept ([QoS Rule(s) and QoS Flow level QoS parameters if needed for the QoS Flow(s) associated with the QoS rule(s)], selected SSC mode, S-NSSAI(s), UE Requested DNN, allocated IPv4 address, interface identifier, Session-AMBR, selected PDU Session Type, [Reflective QoS Timer] (if available), [P-CSCF address(es)], [Control Plane Only indicator], [Header Compression Configuration], [Always-on PDU Session Granted], [Small Data Rate Control parameters], [Small Data Rate Control Status], [Serving PLMN Rate Control], [PVS FQDN(s) and/or PVS IP address(es)]))). If multiple UPFs are used for the PDU Session, the CN Tunnel Info contains tunnel information related with the UPFs that terminate N3.

The N2 SM information carries information that the AMF shall forward to the (R)AN which includes User Plane Security Enforcement information is determined by the SMF as described in step 8 or step 12.

At step 15. AMF to (R)AN: N2 PDU Session Request (N2 SM information, NAS message (PDU Session ID, N1 SM container (PDU Session Establishment Accept)), [CN assisted RAN parameters tuning]). The N2 SM information carries information includes User Plane Security Enforcement information is determined by the SMF as described in step 8 or step 12.

At step 16. (R)AN to UE: The (R)AN may issue AN specific signaling exchange with the UE that is related with the information received from SMF. For example, in the case of a NG-RAN, an RRC Connection Reconfiguration may take place with the UE establishing the necessary NG-RAN resources related to the QoS Rules for the PDU Session request received in step 15. The gNB/ng-eNB shall send the RRC Connection Reconfiguration message to the UE for UP security activation containing indications for the activation of UP integrity protection and ciphering for each DRB according to the security configuration from step 15.

At step 17. (R)AN to AMF: N2 PDU Session Response (PDU Session ID, Cause, N2 SM information (PDU Session ID, AN Tunnel Info, List of accepted/rejected QFI(s), User Plane Enforcement Policy Notification)). The NG-RAN rejects the establishment of UP resources for the PDU Session when it cannot fulfil User Plane Security Enforcement information with a value of

Required. The NG-RAN notifies the SMF when it cannot fulfil a User Plane Security Enforcement with a value of Preferred.

At step 18. AMF to SMF: Nsmf_PDUSession_UpdateSMContext Request (SM Context ID, N2 SM information, Request Type). The AMF forwards the N2 SM information received from (R)AN to the SMF.

At step 19. The SMF initiates an N4 Session Modification procedure with the UPF. The SMF provides AN Tunnel Info to the UPF as well as the corresponding forwarding rules. The UPF provides an N4 Session Modification Response to the SMF.

At step 20. SMF registers into UDM for the PDU session.

At step 21. SMF to AMF: Nsmf_PDUSession_UpdateSMContext Response (Cause).

Some steps such as steps 7, 10 and 12 are new steps according to embodiments of the present disclosure. Some steps may be same as the cooresponding steps as described in 3GPP TS 23.502 V17.5.0.

In an embodiment, to solve problem 1, NEF 5G LAN parameter provisioning interface is improved, so that an external application function or external enterprise application or external vertical application could configure the same user plane security for a certain 5G VN group. Also, UDM parameter provisioning interface is improved to allow NEF to provision the same user plane security into UDM for a certain 5G VN group.

In an embodiment, to solve problem 2, UDM parameter provisioning interface is improved to allow NEF to provision the same user plane security into UDM for a certain 5G VN group. UDR group management data interface is improved to provision the same user plane security into UDR for a certain 5G VN group by UDM or by a communication service provider's provisioning system.

In an embodiment, to solve problem 3, a conflicting resolving mechanism is recommended that the same user plane security of the 5G VN group is enforced if the PDU session is established for a group communication. If the PDU session is established for a non-group level communication, the user plane security configured at individual level shall be used.

In an embodiment, a new method exposed by NEF to external application function or external enterprise application or vertical applications for configuration the same user plane security of a certain 5G VN group which shall be enforced during the group level communications. The mentioned configuration further includes the operations of creation, updating and deletions.

In an embodiment, a new method exposed by UDM for configuration the same user plane security of a certain 5G VN group which shall be enforced during group level communications. The mentioned configuration further includes the operations of creation, updating and deletion. One of the consumers for this service is NEF which when accept the requests from external application or external enterprise application or external vertical applications to configure the same user plane security for a certain 5G VN group which is managed by the corresponding UDM.

In an embodiment, a new method exposed by UDR for configuration the same user plane security of a certain 5G VN group which shall be enforced during group level communications. One of the consumers for this service is UDM which when accept the requests from NEF to configure same user plane security for a certain VN group which is managed by the corresponding UDR.

In an embodiment, a new method in SMF to decide which user plane security configuration shall be used, if PDU session is established for a group level communication, the user plane security configured at group level shall take precedence. If individual PDU session is established for non-group level communication, then user plane security at individual level shall take precedence.

Embodiments herein may provide many advantages, of which a non-exhaustive list of examples follows. In some embodiments herein, the proposed solution can enable the possibility for external application or external enterprise application or vertical applications to configure the same user plane security of a VN group, this enhances the openness of communication service provider to monetize the diversified traffic carried by the network and enable more use cases for the network especially for vertical industries with requirements on same user plane security. In some embodiments herein, the proposed solution can enhance the manageability for same user plane security of VN groups, with the supported new configuration operations for creation, updating and deletion of the same user plane security in a unified service-based interfaces for VN groups. The deficiency and OPEX (operational expenditure) of the VN group management on the same user plane security is reduced. In some embodiments herein, with the recommended user plane security conflicting resolution mechanism, the flexibility is achieved to configure simultaneously the user plane security at individual level and at group level, and user plane security may be set differently for PDU session established for group communication than the one established for individual communication. In some embodiments herein, to reduce incremental complexity added by security, all PDU sessions associated with a specific LAN group should have the same user plane security configuration. This can be easily ensured by the proposed new methods on the user plane security enhancement for VN groups otherwise it would be time-consuming and laborious to rely solely on manual work to ensure that all the PDU sessions associated with a specific VN (such as 5G LAN) group have the same user plane security configuration. The embodiments herein are not limited to the features and advantages mentioned above. A person skilled in the art will recognize additional features and advantages upon reading the following detailed description.

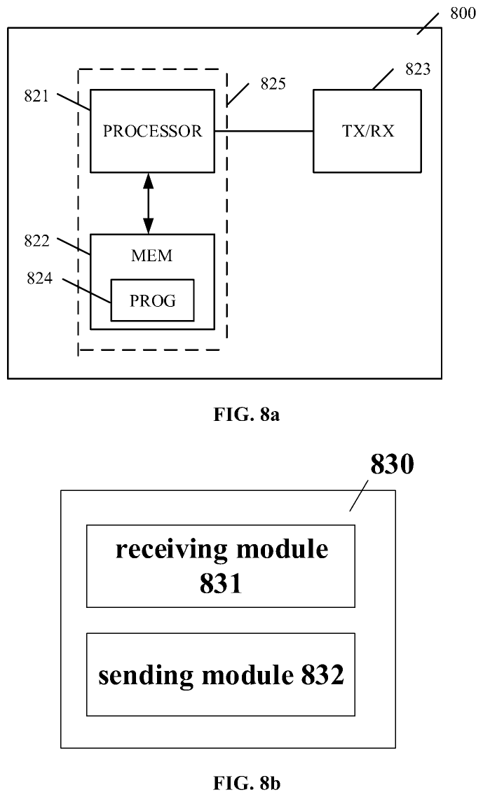

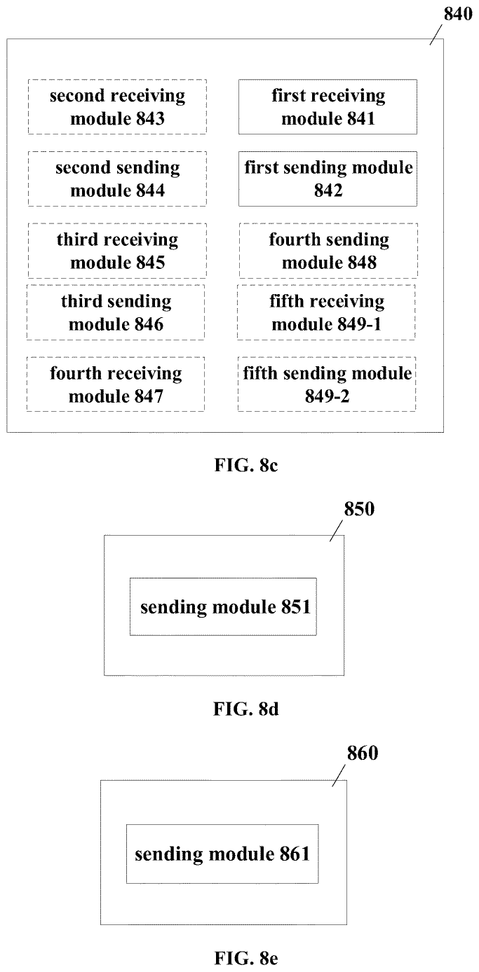

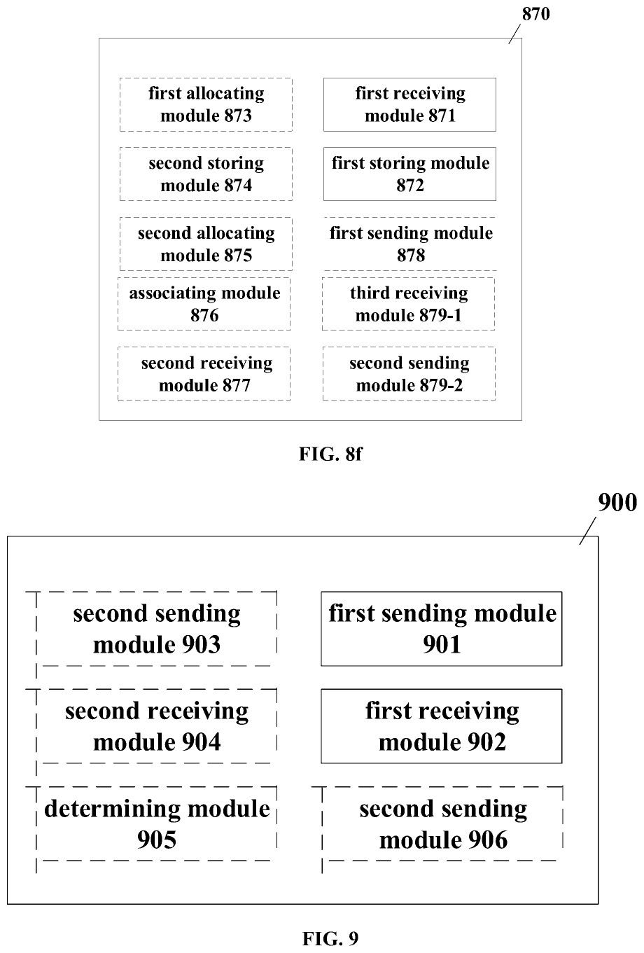

FIG. 8a is a block diagram showing an apparatus suitable for practicing some embodiments of the disclosure. For example, the exposure function, the data management node, the application node, the network management node, the data repository node, or the session management function described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the exposure function, the memory 822 contains instructions executable by the processor 821, whereby the exposure function operates according to any of the methods related to the exposure function as described above.

In an embodiment where the apparatus is implemented as or at the data management node, the memory 822 contains instructions executable by the processor 821, whereby the data management node operates according to any of the methods related to the data management node as described above.

In an embodiment where the apparatus is implemented as or at the application node, the memory 822 contains instructions executable by the processor 821, whereby the application node operates according to any of the methods related to the application node as described above.

In an embodiment where the apparatus is implemented as or at the network management node, the memory 822 contains instructions executable by the processor 821, whereby the network management node operates according to any of the methods related to the network management node as described above.

In an embodiment where the apparatus is implemented as or at the data repository node, the memory 822 contains instructions executable by the processor 821, whereby the data repository node operates according to any of the methods related to the data repository node as described above.

In an embodiment where the apparatus is implemented as or at the session management function, the memory 822 contains instructions executable by the processor 821, whereby the session management function operates according to any of the methods related to the session management function as described above.

FIG. 8b is a block diagram showing an exposure function according to an embodiment of the disclosure. As shown, the exposure function 830 may comprise a receiving module 831 configured to receive a first message comprising at least one parameter to be created or updated from an application node. The at least one parameter to be created or updated may comprise user plane (UP) security information for a virtual network (VN) group. The exposure function 830 may further comprise a sending module 832 configured to send a second message comprising the at least one parameter to be created or updated to a data management node or a data repository node.

FIG. 8c is a block diagram showing a data management node according to an embodiment of the disclosure. As shown, the data management node 840 may comprise a first receiving module 841 configured to receive a second message comprising at least one parameter to be created or updated from an exposure function or an application function (AF). The at least one parameter to be created or updated may comprise user plane (UP) security information for a virtual network (VN) group. The data management node 840 may further comprise a first sending module 842 configured to send a third message comprising the at least one parameter to be created or updated to a data repository node.

In an embodiment, the data management node 840 may further comprise a second receiving module 843 configured to receive a first request for retrieving shared data for the VN group from a session management function.

In an embodiment, the data management node 840 may further comprise a second sending module 844 configured to send a second request for retrieving shared data for the VN group to the data repository node.

In an embodiment, the data management node 840 may further comprise a third receiving module 845 configured to receive a second response comprising shared data for the VN group from the data repository node.

In an embodiment, the data management node 840 may further comprise a third sending module 846 configured to send a first response comprising shared data for the VN group to the session management function. The shared data for the VN group may comprise the UP security information for the VN group.

In an embodiment, the data management node 840 may further comprise a fourth receiving module 847 configured to receive a third request for subscribing data change notification for the VN group from a session management function.

In an embodiment, the data management node 840 may further comprise a fourth sending module 848 configured to send a fourth request for subscribing data change notification for the VN group to the data repository node.

In an embodiment, the data management node 840 may further comprise a fifth receiving module 849-1 configured to receive a first data change notification message comprising the UP security information for the VN group from the data repository node.

In an embodiment, the data management node 840 may further comprise a fifth sending module 849-2 configured to send a second data change notification message comprising the UP security information for the VN group to the session management function.

FIG. 8d is a block diagram showing an application node according to an embodiment of the disclosure. As shown, the application node 850 may comprise a sending module 851 configured to send a first message comprising at least one parameter to be created or updated to an exposure function or a data management node or a data repository node. The at least one parameter to be created or updated may comprise user plane (UP) security information for a virtual network (VN) group.

FIG. 8e is a block diagram showing a network management node according to an embodiment of the disclosure. As shown, the network management node 860 may comprise an sending module 861 configured to send a fourth message comprising at least one parameter to be created or updated to a data repository node. The at least one parameter to be created or updated may comprise user plane (UP) security information for a virtual network (VN) group.

FIG. 8f is a block diagram showing a data repository node according to an embodiment of the disclosure. As shown, the data repository node 870 may comprise a first receiving module 871 configured to receive a message comprising at least one parameter to be created or updated from a data management node or an exposure function or an application node or a network management node. The at least one parameter to be created or updated may comprise user plane (UP) security information for a virtual network (VN) group. The data repository node 870 may further comprise a first storing module 872 configured to store the at least one parameter to be created or updated.

In an embodiment, the data repository node 870 may further comprise a first allocating module 873 configured to allocate an internal group identifier (ID) if the internal group identifier is not allocated for the VN group identified by an external group ID.

In an embodiment, the data repository node 870 may further comprise a second storing module 874 configured to store a mapping between the internal group ID and the external group ID.

In an embodiment, the data repository node 870 may further comprise a second allocating module 875 configured to allocate a shared data ID for VN group data.

In an embodiment, the data repository node 870 may further comprise an associating module 876 configured to, for each member of the VN group, associate session management data with the internal group ID and the shared data ID.

In an embodiment, the data repository node 870 may further comprise a second receiving module 877 configured to receive a request for retrieving shared data for the VN group from a data management node or a session management function.

In an embodiment, the data repository node 870 may further comprise a first sending module 878 configured to send a response comprising shared data for the VN group to the data management node or a session management function. The shared data for the VN group may comprise the UP security information for the VN group.

In an embodiment, the data repository node 870 may further comprise a third receiving module 879-1 configured to receive a request for subscribing data change notification for the VN group from a data management node or a session management function.

In an embodiment, the data repository node 870 may further comprise a second sending module 879-2 configured to send a data change notification message to the data management node or a session management function. The data change notification message may comprise the UP security information for the VN group.

FIG. 9 is a block diagram showing a session management function according to an embodiment of the disclosure. As shown, the session management function 900 may comprise a first sending module 901 configured to send a request for retrieving shared data for a VN group to a data management node or a data repository node. The session management function 900 may further comprise a first receiving module 902 configured to receive a response comprising shared data for the VN group from the data management node or the data repository node. The shared data for the VN group may comprise UP security information for the VN group.

In an embodiment, the session management function 900 may further comprise a second sending module 903 configured to send a request for subscribing data change notification for the VN group to the data management node or a data repository node.

In an embodiment, the session management function 900 may further comprise a second receiving module 904 configured to receive a data change notification message from the data management node or a data repository node. The data change notification message may comprise the UP security information for the VN group.

In an embodiment, the session management function 900 may further comprise a determining module 905 configured to determine whether a protocol data unit (PDU) session establishment is for an individual or group level communication.

In an embodiment, the session management function 900 may further comprise a second sending module 906 configured to, when the PDU session establishment is for the group level communication, set same user plane security data from the UP security information for the VN group into a PDU session request to a radio access network through an access and mobility function.

The term unit or module may have conventional meaning in the field of electronics, electrical devices and or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the exposure function, the data management node, the application node, the network management node, the data repository node, or the session management function may not need a fixed processor or memory, any computing resource and storage resource may be arranged from the exposure function, the data management node, the application node, the network management node, the data repository node, or the session management function in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-71. (canceled)

72. A method performed by an apparatus configured to implement an exposure function, the method comprising:
receiving a first message comprising at least one parameter to be created or updated from an application node, wherein the at least one parameter to be created or updated comprises user plane (UP) security information for a virtual network (VN) group; and
sending a second message comprising the at least one parameter to be created or updated to a data management node or a data repository node.

73. The method according to claim 72, wherein the VN group comprises a fifth generation VN group and/or wherein the UP security information for the VN group indicates same UP security is applied for the VN group.

74. The method according to claim 72, wherein the UP security information for the VN group comprises at least one of:
an information element indicating whether UP integrity protection is required, preferred, or not needed for traffic on a protocol data unit (PDU) session; or
an information element indicating whether UP confidentiality protection is required, preferred, or not needed for traffic on a PDU session.

75. The method according to claim 72, wherein:
the first message comprises at least one of a parameter provision create request or a parameter provision update request; and/or
the second message comprises at least one of a parameter provision create request or a parameter provision update request.

76. The method according to claim 72, wherein:
the application node comprises at least one of:
an application function (AF),
a services capability server (SCS), or
an application server (AS); and/or
the data management node comprises a unified data management (UDM) and/or the data repository node comprises a home subscriber server (HSS) or a home location register (HLR); and/or
the exposure function comprises at least one of:
a service capability exposure function (SCEF),
a network exposure function (NEF), or
a SCEF combined with NEF.

77. A method performed by a data management node, the method comprising:
receiving a second message comprising at least one parameter to be created or updated from an exposure function or an application function (AF), wherein the at least one parameter to be created or updated comprises user plane (UP) security information for a virtual network (VN) group; and
sending a third message comprising the at least one parameter to be created or updated to a data repository node.

78. The method according to claim 77, wherein the VN group comprises a fifth generation VN group and/or wherein the UP security information for the VN group indicates same UP security is applied for the VN group.

79. The method according to claim 77, wherein the UP security information for the VN group comprises at least one of:
an information element indicating whether UP integrity protection is required, preferred, or not needed for traffic on a protocol data unit (PDU) session, or
an information element indicating whether UP confidentiality protection is required, preferred, or not needed for traffic on a PDU session.

80. The method according to claim 77, wherein:
the second message comprises at least one of a parameter provision create request or a parameter provision update request; and/or
the third message comprises at least one of a data management create request or a data management update request.

81. The method according to claim 77, wherein:
the data repository node comprises a unified data repository (UDR);
the data management node comprises a unified data management (UDM); and/or
the exposure function comprises a network exposure function (NEF).

82. The method according to claim 77, further comprising:
receiving a first request for retrieving shared data for the VN group from a session management function;
sending a second request for retrieving shared data for the VN group to the data repository node;
receiving a second response comprising shared data for the VN group from the data repository node; and
sending a first response comprising shared data for the VN group to the session management function,
wherein the shared data for the VN group comprises the UP security information for the VN group.

83. The method according to claim 77, further comprising:
receiving a third request for subscribing data change notification for the VN group from a session management function;
sending a fourth request for subscribing data change notification for the VN group to the data repository node;
receiving a first data change notification message comprising the UP security information for the VN group from the data repository node; and
sending a second data change notification message comprising the UP security information for the VN group to the session management function.

84. A method performed by an application node, the method comprising:
sending a first message comprising at least one parameter to be created or updated to an exposure function or a data management node or a data repository node, wherein the at least one parameter to be created or updated comprises user plane (UP) security information for a virtual network (VN) group.

85. The method according to claim 84, wherein the VN group comprises fifth generation VN group and/or wherein the UP security information for the VN group indicates same UP security is applied for the VN group.

86. The method according to claim 84, wherein the UP security information for the VN group comprises at least one of:
an information element indicating whether UP integrity protection is required, preferred, or not needed for traffic on a protocol data unit (PDU) session, or
an information element indicating whether UP confidentiality protection is required, preferred, or not needed for traffic on a PDU session.

87. The method according to claim 84, wherein the first message comprises at least one of a parameter provision create request or a parameter provision update request.

88. The method according to claim 84, wherein one or more of:
the application node comprises at least one of:
an application function (AF),
a services capability server (SCS), or
an application server (AS);
the exposure function comprises at least one of:
a service capability exposure function (SCEF),
a network exposure function (NEF), or
a SCEF combined with NEF;
the data repository node comprises at least one of:
a home subscriber server (HSS), or
a home location register (HLR); and/or
the data management node comprises a unified data management (UDM).
